(19) United States
(12) Patent Application Publication
(10) Pub. No.: US 2025/0232233 A1
(43) Pub. Date: Jul. 17, 2025

(54) System and Method for Development and Management of Entertainment Projects

(71) Applicant: Fable Entertainment, Inc., Los Angeles, CA (US)

(72) Inventor: Yuval Shrem, Los Angeles, CA (US)

(73) Assignee: Fable Entertainment, Inc., Los Angeles, CA (US)

(21) Appl. No.: 19/067,394

(22) Filed: Feb. 28, 2025

Related U.S. Application Data
(63) Continuation of application No. 18/579,206, filed on Jan. 12, 2024, now abandoned.
(60) Provisional application No. 63/222,845, filed on Jul. 16, 2021.

(51) Int. Cl. G06Q 10/0631

(52) U.S. Cl. CPC G06Q 10/063118; G06Q 10/06312; G06Q 10/06313; G06Q 10/06314

(57) ABSTRACT

A modular content development and production management tool and associated methods are disclosed. In at least one embodiment, upon a new entertainment production being added to the system, the system generates an at least one candidate schedule containing each of the resources for each planned scene in a shot list for said entertainment production, based on the resource availability associated with each of said resources. Additionally, the system generates a total schedule cost for each candidate schedule based on an aggregate of the resource cost associated with the resource availability for each of the resources in said candidate schedule. The system selects a one of the at least one candidate schedule, establishes a resource reservation for each of the resources based on the resource availability for each of the resources in said selected candidate schedule, and generates a master schedule containing each of the resource reservations for said entertainment production.

### RELATED APPLICATIONS

This application is a continuation of U.S. National Phase entry, Ser. No. 18/579,206, filed Jan. 12, 2024, which claims priory to PCT Application No. PCT/US2022/037217, filed Jul. 14, 2022, which claims priority and is entitled to the filing date of U.S. provisional application Ser. No. 63/222,845, titled “System and Method for Development and management of Entertainment Projects, filed on Jul. 16, 2021, the contents of which are incorporated herein by reference in their entirety.

### BACKGROUND

The subject of this patent application relates generally to a system and associated methods for developing, writing, and managing entertainment projects, and more particularly, it includes a unique and powerful entertainment production management system.

Applicant hereby incorporates herein by reference any and all patents and published patent applications cited or referred to in this application.

By way of background, management tools may assist in all aspects of developing entertainment content, including writing, pitching, planning, and managing casting, crewing, and scheduling as well as generating automatic cost estimates based on different scheduling scenarios. Entertainment content can include film productions, television productions, plays and musical plays for stage productions, commercials, music videos, concert tours, corporate videos, video games, reality shows, documentaries, music concert tours, etc. The system supports both fully scripted projects and unscripted projects that make use of the loose script format.

The problem that exists with the currently available tools and systems, is that those tools and systems are segmented, and are not all connected to a single database, and thus require a large amount of redundant manual work, and are prone to many types of errors and wasted time, money and resources.

Additionally, the segmentation of the existing systems causes significant difficulty to keep everything updated and synchronized when changes are made.

The invention, by integrating many of the functions into one unified system, is able to add a lot of new functionality, that in turn, streamlines the process, improves both the communication and the work flow, automates what is otherwise are time-consuming and error prone processes, and saves time and money.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give

rise to the exemplary advantages described below.

An embodiment of the present invention features a novel content development and production management tool for producing a film or other entertainment product. Management tools assist in all aspects of developing the content, from writing, pitching, planning, and managing casting, crewing, and scheduling as well as generating automatic cost estimates based on different scheduling scenarios. Entertainment products include film productions, television productions, plays for stage productions, commercials, music videos, concert tours, corporate videos, video games, and unscripted projects, such as reality shows, documentaries, music concert tours, and in some cases, narrative film/television projects that use the loose script format, such as prank shows, etc.

In particular, the present invention provides automatic scheduling assistance in the planning, scheduling, and schedule confirmations. The system, when fed with the appropriate availability information of cast, crew and filming locations, can suggest production schedules, alert users when scheduling errors occur, and can even automatically contact all of relevant personnel to confirm schedule changes when needed. The present invention can be configured to contact team members for scheduling confirmation through email, text, phone (voice message +dialing selections) or through push notifications within the software application, depending on user preferences. Changes in the script are automatically reflected in the budget and schedule.

The present invention seeks to fit into existing industry and the existing workflows and work pipelines currently used in industry. As such, some elements and aspects described in the present invention may seem similar to prior art systems in order to appear familiar to potential users, however, the present invention in its totality—as well as many of the specific features and implementations—is novel and unique and, therefore, offers new processes and tools that do not exist in the market today.

In some embodiments, the present invention is uniquely integrated with relevant unions and guilds to help calculate the costs associated with each union, as well as make it much easier to comply with each union's rules pertaining to documents to be signed each day, lunch breaks, and location-specific rules.

In some embodiments, the present invention incorporates a weather report configured to alert production of problematic weather on scheduled exterior filming days, and suggest scheduling alternatives.

In some embodiments, the present invention includes management of casting calls for purposes of publishing casting calls on existing systems, as well as on the present software application. The invention can also then manage submissions coming from actors and their representatives, including audition scheduling, casting process management using uploaded videos from scheduled auditions, as well as self-tape uploads.

In some embodiments, the invention may also be configured to manage post-production, completed production, and post-release. Post-production includes editing, ADR recordings, sound design, color grading, visual effects, sound mixing, etc. The post-release includes the tracking of residuals and royalty payments based, for example, on the release and distribution.

Additionally, the present invention solves the problems described above by providing a system and associated methods for managing entertainment production resources and dynamically generating production schedules and production budgets based on an availability of said resources. In at least one embodiment, a server is configured for receiving and processing data related to a plurality of members associated with an at least one entertainment production and a plurality of resources associated with the at least one entertainment production. A master schedule module in memory on the server is configured for storing the data related to the members and resources associated with the at least one entertainment production. A scenario generator in memory on the server is configured for generating a plurality of candidate schedules for the at least one entertainment production. A cost estimator module in memory on the server is configured for generating cost estimates for each candidate schedule based on a set of cost details accessible by the server, said cost details including at least one of a general cost rule or a union pay rule. In at least one embodiment, upon a new entertainment production being added to the master schedule module, the master schedule module receives a scene or shot list containing a plurality of planned scenes for said entertainment production. For each planned scene in the scene or shot list, the master schedule module generates a resource list containing each of the plurality of resources associated with said planned scene; and for each resource in the resource list, the master schedule module generates a resource schedule containing an at least one resource availability for said resource, each of the at least one resource availability being a date and time at which said resource is currently available to be used for said entertainment production. The cost estimator module generates a resource cost for each of the at least one resource availability in the resource schedule based on the set of cost details accessible by the server. The scenario generator generates an at least one candidate schedule containing each of the resources in the scene or shot list, based on the resource availability associated with each of said resources along with an at least one resource rule associated with each of said resources. For each of the at least one candidate schedule, the cost estimator module generates a total schedule cost for said candidate schedule based on an aggregate of the resource cost associated with the resource availability for each of the resources in said candidate schedule. The master schedule module selects a one of the at least one candidate schedule and establishes a resource reservation for each of the resources based on the resource availability for each of the resources in said selected candidate schedule. The master schedule module then generates a master schedule containing each of the resource reservations for said entertainment production.

In a bit more detail, in at least one embodiment, the system provides automatic scheduling assistance in the planning, scheduling, and schedule confirmations. The system, when fed with the appropriate availability information of cast, crew and filming locations, can suggest production schedules, alert users when scheduling errors occur, and can even automatically contact all of relevant personnel to confirm schedule changes when needed. In at least one embodiment, the system can be configured to contact team members for scheduling confirmation through email, text, phone (voice message+dialing selections) or through push notifications within the software application, depending on user preferences. Changes in the script are automatically reflected in the budget and schedule.

In at least one embodiment, the system seeks to fit into existing industry and the existing workflows and work pipelines currently used in industry. As such, some elements and aspects described herein may seem similar to prior art systems in order to appear familiar to potential users; however, the system in its totality-as well as many of the specific features and implementations described herein-is novel and unique and, therefore, offers new processes and tools that do not exist in the market today.

In at least one embodiment, the system is uniquely integrated with relevant unions and guilds to help calculate the costs associated with each union, as well as make it much easier to comply with each union's rules pertaining to documents to be signed each day, lunch breaks, and location-specific rules.

In at least one embodiment, the system incorporates a weather report configured to alert production of problematic weather on scheduled exterior filming days, and suggest scheduling alternatives.

In at least one embodiment, the system includes management of casting calls for purposes of publishing casting calls on existing systems, as well as on the present software application. The system can also then manage submissions coming from actors and their representatives, including audition scheduling, casting process management using uploaded videos from scheduled auditions, as well as self-tape uploads.

In at least one embodiment, the system may also be configured to manage post-production, completed production, and post-release. Post-production includes editing, ADR recordings, sound design, color grading, visual effects, sound mixing, etc. The post-release includes the tracking of residuals and royalty payments based, for example, on the release and distribution.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a functional block diagram of an exemplary entertainment management system, in accordance with at least one embodiment;

FIG. 2 is a flow diagram of an exemplary method for generating an initial schedule and budget from an at least one script, in accordance with at least one embodiment;

FIG. 3 is a flow diagram of an exemplary method for updating a schedule and cost estimate based on a change, in accordance with at least one embodiment;

FIG. 4 is a flow diagram of an exemplary method for identifying a candidate schedule, in accordance with at least one embodiment;

FIG. 5 is an illustration of a plurality of exemplary schedules for identifying a candidate schedule, in accordance with at least one embodiment;

FIG. 6 is an illustration of an exemplary approved production schedule, in accordance with at least one embodiment; and

FIG. 7 is a flow diagram of an exemplary a system and associated methods for developing, writing, and managing entertainment projects, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

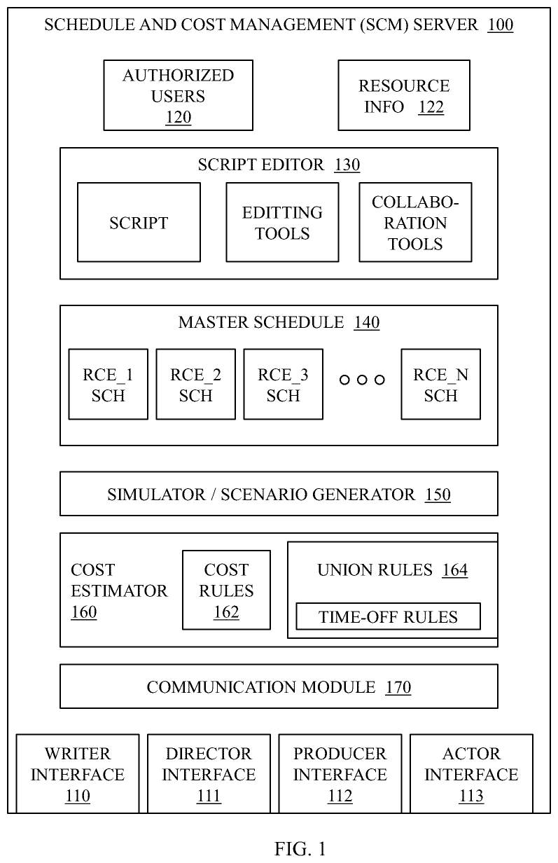

Turning now to FIG. 1, there is shown a functional block diagram of an exemplary entertainment management system, in accordance with at least one embodiment. In at least one embodiment, the system and associated methods are configured for assisting with the development and management of film projects and other entertainment products (collectively hereinafter referred to generally as “entertainment products” or “products” for simplicity purposes). In particular, in at least one embodiment, the system and associated methods are configured for tracking the availability of all resources in connection with the production and generating a schedule and cost estimate for the production. Moreover, as new information about the availability of the resources becomes available, the schedule and cost estimate can be automatically updated based on this information and reported to those parties that make decisions. Resources include all assets needed for production, including living resources (c.g., human actors, animal actors, stunt doubles, dancers, musicians, production team, creative team, crew, etc.) and non-living resources (c.g., locations, sets, props, scene equipment, musical instruments, etc.) to name a few. In at least one embodiment, a further type of resource are non-member resources—namely, resources that are living resources who are not members in the project, or non-living resources that are handled by people or companies that are not members in the project and would have a member in the project (typically a department head) assigned as responsible to that resource. In at least one such embodiment, all three types of resources have at least one data entry defining who is responsible for that resource. In case of human resources, this might be the actor himself and/or their representative for example. In case of a non-living resource, it may be the person responsible for creating the resource, or the department head coordinating it by outsourcing to a non-member resource.

Additionally, each project may be signatory with one or more unions or guilds, which becomes part of the project settings and affects the calculations of schedule, budget and cast and crew. The project can also be non-union.

The term “scene” can include one or more of the following, or any combination of same: at least one scene, at least one segment, at least one song, or at least one shot in at least one shot list. A single project or a single script can have any combination of scenes, segments, songs or shots in a shot list.

With continued referenced to FIG. 1, in at least one embodiment, the system includes a server 100 that is accessible via the Internet to all parties involved in the production of the entertainment product (hereinafter referred to generally as “projects” for simplicity purposes). The parties involved in the production of the entertainment products may include, but are not limited to, writers, directors, producers, actors, and a wide range of other people and entities including film equipment rentals, costume rentals, prop rentals, catering companies, etc. Additionally, in at least one embodiment, the at least one project is comprised of a plurality of project units, with each project unit consisting of its own set of crew members, production team, creative team, etc. Those units may operate in parallel to one another, or at different times.

In at least one embodiment, the system also includes a script database in communication with the server 100 and configured for storing the at least one script for a given project (hereinafter referred to generally as a “script” for simplicity purposes, intending to include situations where a given project includes multiple scripts). In at least one embodiment, the system also includes a resource database in communication with the server 100 and configured for storing select details associated with each resource for a given project, said select details including but not limited to associated pricing rules for each resource, scheduling rules for each resource, and the availability for each resource (and what has to happen before each resource can be used).

In at least one embodiment, to enable communication, the server 100 includes one or more of a user interface for the writer(s) 110, a user interface for the director 111, a user interface for the producer 112 (also applies to line producer, production manager, and/or first assistance director), a user interface for the casting director (as discussed further below), a user interface for the actors 113 (as discussed further below), a user interface for the cinematographer (as discussed further below), as well as user interfaces for all the other people and entities required for production. In at least one embodiment, any person or entity having an account on the server 100 and access to at least some of the scheduling data is referred to herein as a “member.” Using their own particular interface, each of the members has access to information relevant to that member and the product or service they provide, as explained in more detail below.

In at least one embodiment, the user interface for the casting director may include a projects panel containing select details related to each of the projects with which a given casting director is currently involved. Thus, in such embodiments, since casting directors tend to work on multiple projects in parallel, there is a list of active projects. Completed projects are archived, to avoid clutter. In at least one embodiment, the casting director calendar is shared across projects to avoid double-booking.

In at least one embodiment, the user interface for the casting director may also include casting breakdowns. The casting breakdowns may include functionality for casting breakdown creation. In at least one such embodiment, for each character to be cast, the casting director creates a character description, and technical requirements such as age range, gender, height, etc. That is the casting breakdown for the character. The character description is used in casting call postings on third party casting services, as well as internally on this new system, and is also used to generate email offers. The casting breakdowns may also include functionality for casting call distribution. In at least one such embodiment, the casting director may distribute the casting calls for the various characters in various ways, depending on the role. For example, a leading role might be offered to star name actors via email offers, while major supporting roles may only be visible to licensed talent agencies, and smaller roles may be visible to actors directly, internally on the present system, and/or externally via various casting websites. By the character list on the casting director interface, cach role can be assigned the types of casting distribution relevant to it specifically. In at least one embodiment, the system can automate the process of posting on casting websites and services. In at least one embodiment, this is visible to actors and talent representatives who are registered users in the system as actors and as talent agents and managers. For this option, the system enables the actors and their representatives to apply for consideration and begin the casting process as described further below. In at least one embodiment, using an editable template, the casting director can generate an offer email to a name actor through their representative, or a request for a meeting or an audition. The system will automatically include the character description in the body of the email, as well as an attachment of the script or audition sides for the character (selectable). It may also automatically include an automatically generated page range list of where in the script the character appears (selectable). The casting director can then further edit the email prior to sending it out.

In at least one embodiment, the user interface for the casting director may also include functionality for automatically generating “sides” (i.c., excerpts from a script that an actor is expected to perform as part of an audition) and instructions for auditions. In at least one embodiment, the system can automatically extract all the scenes that include the relevant character and make them available to the casting director in the form of audition sides. The casting director may choose which scenes or portions of scenes to include and may even edit those segments for auditioning purposes. In at least one embodiment, the auditioning role is automatically highlighted by default. In at least one embodiment, the casting director may have special instructions, either technical notes for a self-tape, parking, or sign-in instructions for an in-person audition, or further information about the character and/or style. Those can be automatically added as needed.

In at least one embodiment, the user interface for the casting director may also include functionality for scheduling auditions. In at least one embodiment, for self-tape auditions, the casting director may set submission deadlines for each role, or for a group of roles. Those are automatically included in any of the distribution methods. In at least one embodiment, for in-person auditions (as well as real-time remote auditions and casting meetings), the casting director may assign a set amount of time for cach role or combination of roles to be auditioned. In at least one embodiment, the casting director can set a day and time for in-person auditions, and specify which roles are being seen on that day at that time. The system will then generate a tentative detailed schedule, assigning specific time slots to specific actors. Actors and their representatives may then confirm, decline, or request rescheduling. Once actors have confirmed their time slots, the schedule becomes officially confirmed. As rescheduling requests, additional confirmations, and surprise cancellations come in, the schedule may update, and similar to rescheduling tools of production scheduling, semi-automatic availability-checks may be generated for adjustments in the schedule, and schedule update notifications generated for confirmed updates in the schedule. This process is also applicable for scheduling call-backs, chemistry-reads and any other steps required by the casting director and/or director and/or producers.

In at least one embodiment, the user interface for the casting director may also include functionality for reviewing and ranking actors (which may also be made available to the director and/or producers in at least one embodiment). In at least one such embodiment, when when the casting director opens a submissions tab in a given project, there is the list of character roles, and a mark for those with new unopened submissions by the corresponding character name. When opening the selected character, the submissions are listed with their current casting status (audition/audition scheduled/call back/call back scheduled/reject/cast/etc.). If the actor has submitted a self-tape, or if they have already auditioned in front of a camera and the audition tape has been uploaded to the system, the video submissions and/or in-person audition tape, and/or recording of their virtual audition (such as over video conference) shows up by their headshots, acting reels and resume. The casting director may decide to share that candidate with the director and/or producers, and in so doing, can also decide which of the headshots and which of the videos to share. This is the initial casting director selecting phase, which reduces the workload required from the director, by removing the candidates who are clearly not right for the project. The casting director (or director) may decide to ask an actor who submitted for a certain role, to audition for another role, cither instead of or in addition to the role they submitted for, if they believe the actor is more suitable for that other role, and the actor may accept or reject the invitation to audition for the other role, at their discretion. In at least one embodiment, similar to the way in which actors may upload their self-tapes, the casting director or their assistants, has a tab in the system, intended for uploading taped in-person auditions and/or recorded virtual auditions (such as over video conference). The upload is assigned to the auditioning actor or actors and their respective role or roles within the specific video. This way, the video will be available on the actor's page within the submissions of the relevant role. In at least one embodiment, the casting director may add written casting notes and attach them to a specific video, or to the submission in general. The casting director can categorize casting notes as private (internal for themselves, not to be shared with the director or producer), or define who to share them with. The casting director may share casting notes with the director, producer, the actor, or their representatives. In at least one embodiment, based on the totality of the media included under the actor's submission, the casting director may rank them as “reject,” “maybe,” “consider for a different role,” “cast,” “call back,” or “share with director/producer.” In at least one such embodiment, the director has similar sorting tools to either finalize casting or narrow down the list of candidates to call back for further casting steps as needed. Once a director makes their final selections, the producers must approve the casting, in order for it to be final and be sent as an official offer to the actor and/or their representatives. Similarly to other parts of the system, discussions between the relevant people can be had within the casting module. In at least one embodiment, once a final “reject,” “call back,” “offer,” or “consider for a different role” decision is made about an actor, a template-based notification is prepared for them. If the casting director wishes to edit the message to personalize it to the specific actor or representative, they can do it prior to it being sent out, but then those messages can be sent in bulk, automatically. For “offer” notifications for roles at standard union rates, a stock contract can be automatically personalized and be sent along with the offer. The type of contract can be set in advance in the character settings. This also enables uploading custom contracts when appropriate.

In at least one embodiment, the user interface for the casting director may also include functionality for locating specialty talent. In at least one embodiment, this enables the casting director to search the database of actors who are members in the system and seck for appropriate talent based on custom search criteria, regardless of submissions by the actors or their representatives. They can then reach out to such actors and invite them to audition (or for a meeting, or just offer them the role). In at least one embodiment, regardless of casting status of an actor, the casting director may add an actor to their “go-to” talent library, with their own custom searchable tags, for future reference.

In at least one embodiment, the user interface for the actors 113 may include one or more scene study tools. In at least one such embodiment, the scene study tools work on scenes in projects the actor is a member in, as well as “sides” given to the actor for an audition. The actor can also import a scene or a full script (or multiple scripts) to use in the system. In at least one embodiment, the system allows actors to use scene study tools based on various methods and schools of acting. Such scene study tools may include scene objectives, scene obstacles, action beats, substitutions, images, stakes/evaluation, physical state, physical characterizations, etc. Additionally, in at least one embodiment, the system allows for blocking notes to be attached to specific points in the script. Both types of notes can be viewed in a visual manner that makes them easy to read and apply, and can be printed as well, if needed. Both types of notes can be shared with the director or an acting coach, and can be discussed within the system. Multiple versions of both types of notes can be saved as alternate versions, and a final selection can be dynamically made and updated.

In at least one embodiment, the user interface for the actors 113 may include one or more character research tools. In at least one embodiment, one such type of tool is a dialect tool, including phonetic spelling, as well as the use of audio recordings from a dialect coach, attached to specific lines in the script, and audio recordings from the actor, sent for review to the dialect coach. In at least one embodiment, another such type of tool is a master cross-project calendar, where all scheduled rehearsals, recording sessions, filming days, and auditions appear, from all projects the actor is a member in (or being considered for through a scheduled audition). The actor can also add blocked “unavailable” times on the master calendar, for external projects or other times in which the actor is unavailable. In at least one embodiment, the actor is able to synchronize the system calendar with an external calendar for seamless integration, automatically blocking times (without exposing the actual external content). In at least one embodiment, another such type of tool is a casting dashboard, allowing for the creation and updating of resumes (can use multiple versions for different types of work); size information for costume fittings (used by costume designers); detailed searchable skills tags, such as languages, vocal range for singers, dance training for dancers, instruments for musicians, and other details of searchable special skills; uploading and/or linking demo reels and performance videos; managing representative permissions on the account; bi-directional alerts and messages between the actor and the representative; access to eligible casting breakdowns; applying to roles appearing on the breakdown, including headshot submission and relevant videos (such as an acting reel, and/or relevant performance video); accessing sides for auditions to which the actor has been invited; “virtual reader” functions for self-tape auditions, enabling the actor to create a self-tape audition without the assistance of an in-person reader, by either reading the lines of the other characters in the scene utilizing synthesized text-to-speech engine, or utilizing a self-made audio recording; scheduling in-person auditions or remote interactive auditions (such as over video conference), once invited; uploading self-tape auditions; and bi-directional communication with the casting director.

In at least one embodiment, the user interface for the actors 113 may include one or more communication tools. In at least one embodiment, one such type of tool enables questions to and from the director and other team members, such as the costume designer, production manager, makeup artist, and others. Such questions are connected to specific scenes in the script, and will also be automatically attached to the filming days in which the relevant scene is scheduled. Such questions (or other types of communication) can be developed into a bi-directional conversation that may include text, audio clips, images, and even video clips as needed. When such a discussion is resolved, the thread is archived, so it doesn't show up as pending and requiring attention. In at least one embodiment, another such type of tool is an availability check confirmation, for when scheduling or rescheduling is required (the actor and/or their representative may respond to availability check inquiry). In at least one such embodiment, if permissions are granted by the actor to the project, the production will have access to their master calendar for initial availability check, so that when a requested time is already marked as unavailable, the system will assume unavailability of the actor during that time, for the purpose of calculating schedule candidates to present to the producers, production manager, and first A.D., which will help minimize tentative planning for impossible schedule.

In at least one embodiment, the user interface for the actors 113 may include one or more union integration tools. In at least one embodiment, one such type of tool allows for union status and locality information to be updated in the actor's account, which automatically populates to projects the actor is a member in, or being considered for. If and when the union approves electronic signatures, the actor may electronically sign union documents through their account in the system. When the project is distributed, information regarding residuals and royalties is reported in the actor's account. This can be part of the compliance module.

In at least one embodiment, the user interface for the actors 113 may include one or more call sheet and scheduling tools for dynamically updating an actor's schedule. In at least one embodiment, whenever the schedule for a filming day is locked in, a “call sheet” is distributed to all cast and crew. This report includes the details of which scene is shot when and determines when each crew member and cast member should report to the set or be picked up. In at least one embodiment, this shows up in the actor's master calendar, email, and overall production schedule, in the form of production call-sheets. If there are any last-minute changes, the actor receives an update and an alert about it.

In at least one embodiment, the user interface for the cinematographer may include one or more conceptual collaboration tools. In at least one embodiment, one such type of tool incorporates look boards and conceptual designs (including reference images from various sources, such as other movies, fine art paintings and photographs, video examples, etc.), by which the cinematographer communicates visual concepts with the director, with the production designer, with the costume designer, and with the colorist. Each of the relevant team members (production designer, costume designer, makeup artist, colorist, location manager or location scout, and of course, the cinematographer and the director) can create their own look boards for the project in general, and/or for specific elements in the project. This enables a collaborative creative brainstorming process that is often used by filmmakers. As opposed to the segmented way look boards are used today, including those in this system, can help keep everyone in the team responsible for the visual side of the project on the same page, in a multi-member virtual brainstorming spacc.

In at least one embodiment, the user interface for the cinematographer may include one or more shot list tools. In at least one embodiment, one such type of tool incorporates shot lists in simple written form (as a table specifying shot size, content, camera movement, lens choice, what is the action and dialog included from the script, and whether or not sound recording is needed). A shot with developing content as a result of characters movement and/or camera movement, may occupy more than a single line in the table. In at least one embodiment, another such type of tool incorporates two-dimensional storyboards, illustrating how cach shot will look, as represented by a single drawing, or, if there is movement of characters and/or camera in the shot, sometimes multiple drawings are used. In at least one such embodiment, the drawings can be imported as images, or created within the software interface, utilizing pre-drawn elements, that are either user created, or selected from a library of drawings. In at least one embodiment, another such type of tool incorporates overhead diagrams determining the position of the actors, as well as the positions of the camera or cameras for cach shot, animating their movements, and exporting a printed version of the diagrams representing cach position of the cameras and the performers. These can also be used for lighting design, planning which lighting fixtures and light modifiers are required and where they need to be positioned, and which grip equipment will be used, and where it is going to be positioned. In at least one embodiment, another such type of tool incorporates three-dimensional previsualizations with real-time rendering utilizing video-game engines, simulating characters movements, camera movements and lighting. This utilizes the plans from the overhead diagrams, images of the actors' faces, and if available, three-dimensional scans of the filming locations, as well as prepackaged motion captured animations, to previsualize the shots in the shot-list. This is especially useful in complicated sequences that include stunts, special effects such as pyrotechnical effects, or complicated visual effects that need to be integrated and require careful planning. This method is also very helpful as a pitching tool (used by the director or producer, when pitching to a client, for a TV commercial, for example). In at least one embodiment, another such type of tool incorporates resource reports, which may initially be automatically generated from the overhead diagrams (if those are used), but regardless, can be further edited and elaborated on. This includes a list of the lighting, camera and grip equipment required for each scene, shot, or a group of shots in a scene. In at least one embodiment, another such type of tool incorporates time estimates—namely, a per-setup estimate of setup time required, as well as crew members required. This may include which crew members can leave the active set, in order to begin setting up the next shot or next scene. In at least one embodiment, these time estimates are combined with the director's time estimates either in a serial or parallel manner, depending on context. For example, the grip may perfect a camera movement, and the gaffer may make fine-tuning adjustments to the lighting, during the time the director is rehearsing with the actors.

In at least one embodiment, the user interface for the cinematographer may include one or more time of day tools. In at least one embodiment, one such type of tool incorporates weather reports connected to the actual location and scheduled date for filming, and updated dynamically via online third-party sources. If a specific weather is required for a certain scene or a shot (for example, no rain in a day exterior scene), this feature will alert about incompatible weather if such incompatible weather is expected at that time, and will be able to suggest alternative times for filming, based on the existing data about the production schedule. The cinematographer may require specific weather characteristics, (an overcast sky, for example) in order to accomplish certain shots. In at least one embodiment, lack of rain in exterior shots is pre-selected by default. In at least one embodiment, another such type of tool incorporates sun position and time of day. There are existing apps to estimate the position of the sun in a given location at a given time as mobile apps. This feature utilizes this existing functionality and integrates it into the system for scheduling purposes. The cinematographer can determine the optimal time and angles to shoot a scene based on the estimated sun position in specific times in the day. This can make an enormous difference in the amount of lighting equipment and setup time required to film a scene. If the cinematographer determines that for certain shots he or she needs the sun to be at a certain angle in relation to the filming location, or needs to shoot a certain shot during “magic hour” or during “golden hour,” they may note a specific time range within which those shots can be filmed, and this limitation is incorporated into the schedule. In at least one embodiment, another such type of tool incorporates preset and pre-light data. The cinematographer may suggest pre-lighting a set or a location, and/or preset complicated grip setups, in the day prior to filming, to enable a more efficient filming day. This is especially relevant to large lighting setups and/or grip setups, such as long dolly runs, that can take many hours to set up. In at least one such embodiment, this is incorporated as a selectable option in the time-estimation of setup time. The producer can then make an informed decision whether to schedule the lighting and/or grip setup for the day of filming or on an carlier date. In at least one embodiment, another such type of tool incorporates footage review functionality (i.e., “dailies”). In at least one such embodiment, footage, including dailies uploaded by the DIT to the cloud, or uploaded through camera-to-cloud workflows, is available to the cinematographer (as well as other members of the cast and crew according to permission settings) to view for review and continuity purposes. In at least one embodiment, the footage includes metadata added by the script supervisor. In at least one embodiment, the footage is attached to specific scenes in the script and specific shots in the shot list, and thus can be located very quickly and easily. In at least one embodiment, another such type of tool incorporates monitoring look-up tables. For example, in at least one such embodiment, the cinematographer or the colorist may provide project-specific look-up tables for the purpose of monitoring the camera during filming, and for dailies.

In at least one embodiment, the server 100 further includes an authorization module 120 configured to regulate access to those authorized users or members. In particular, the authorization module 120 includes a list of all parties authorized to log on to the server 100 as well as their respective usernames and passwords. Once logged in, each member has access to one or more resources listed in a resource information module 122 provided by the server 100. A resource, as used herein, refers to all tangible and intangible elements directly involved in the production of the entertainment products, from inception to pre-production, production, post production and distribution. Resources include, but are not limited to, the script, actors, props, costumes, filming locations, camera equipment, sound equipment, and lighting equipment, to name a few, as well as proxies of and actual filmed footage or recorded material, once production begins. In at least one embodiment, each of these resources is then tracked via the server 100 so that different people and entities may view and change information concerning the availability of those resources. For example, in at least one embodiment, the writers and actors have access to the script, cach vendor providing rental equipment has access to a list of the equipment provided by that vendor, the costume rental company has access to a list of costumes provided by the company, etc. In at least one embodiment, the producers, by contrast, have access to cost and scheduling information provided by all parties with access to the server 100. In at least one embodiment, prior to a vendor, supplier, or other entity being assigned an account and provided an interface, the producer may create an entry for the vendor's resource and the producer enter the cost and schedule information directly, at least until the vendor is officially recognized by the server 100.

In at least one embodiment, the server 100 is managed by an administrator with the power to add and remove members and to add and remove various privileges of those members as necessary. These privileges may include the ability (1) to view various forms of cost and scheduling information, or (2) to edit that cost and scheduling information. In the preferred embodiment, no one party has the ability to view the information provided by all the members or the communications of those members so as to ensure the integrity of private communication throughout the creative process.

In at least one embodiment, the server 100 further includes a script writing and editing/development module 130 which includes a current version of the script as well as changes to the script, editing tools for revising the script as necessary, and collaboration tools by which the writers can collaborate with each other and with the director, the producer and others prepare drafts, review drafts, propose changes, review changes, and accept changes to the script. Using the editing tools, the writer and director, for example, can make changes to the script using both real time and non-real time collaboration tools, and have those revisions approved by the producer and automatically available to the actors or other people that are affected by the change, as well as automatically reflect in the production schedule and budget, if the revisions affect those.

It should be noted that the term “script” as used herein refers to a written treatment or document that includes substantially all of the scenes, descriptions and dialog for the entertainment product. Examples of scripts include screenplays, teleplays for television productions, plays for stage productions, A/V scripts for commercials, music videos, and corporate videos, non-linear interactive scripts (for video games), voiceover/ADR scripts, and unscripted projects that use loose scripts, such as reality shows, documentaries, music concert tours, and in some cases, narrative film/television projects that use the loose script format, such as prank shows, comedy shows, and some drama shows. While the server 100 may be configured to manage production of a single movie, it may also be configured to manage production of an entire multi-episode show such as a television show. In the case of a multi-episode show, each episode is associated with a different script but the multiple episodes are collectively developed and managed as a single project with a long term schedule and budget.

In at least one embodiment, the editing and collaboration tools include a variety of different tools. In at least one embodiment, the tools include a style checker configured for detecting a writing style and common formatting errors specific to screenwriting. Those errors can then be marked and suggested corrections offered.

In at least one embodiment, the tools include a plot step list configured for assisting with structuring the story development of the script without having to write it all in full script form in a linear manner.

In at least one embodiment, the tools include a story timeline viewer configured for keeping track of the chronological chain of events of the story, in scripts that are told in a non-linear order, jumping back and forth in time and include off screen events that affect the story. Using this tool, the writer can arrange the scenes (along with the plot step-list) in the chronological order and even include off-screen events that are not included in the script itself, which makes it easier to keep plot consistency in such challenging scripts. Even in scripts with a linear storytelling, this is where either the writer or someone else will be assigning “script day” and “script time” to each scene. Those markers will be used by the costume and makeup departments, as well as the actors for continuity and a sense of time.

In at least one embodiment, the tools include a thread tracker configured for tracking threads (i.c., collections of scenes, events, images, or even single lines of dialog, that are related to each other and work in combination with one another to create a larger meaning). The most obvious types of threads are “setup and payoff” and a “running gag,” but threads can be more subtle than that and still be just as strongly connected. Keeping track of threads is incredibly important during rewriting, because often when a scene is cut or changed, the other scenes connected to it by such threads must be changed as well, for the thread to make sense. Often if one portion of the thread is removed from one scene, the entire thread must be removed from all of the scenes it is included in. By tagging elements in the script as belonging to a certain thread, the thread tracker makes it much easier to see in a glance, all of the components of the thread and assess necessary changes. This is also helpful in finding and removing redundancies in the script during rewrites, and for finding and resolving broken threads such as a setup without a payoff, etc.

In at least one embodiment, the tools include a version controller configured for detecting version conflicts and assisting to resolve those conflicts. when more than one person works on the script, and also helps to keep track of who make which changes and when. It also makes editing the script non-destructive, by saving all of the versions in the cloud for easy access in case a member wants to go back, or bring back an element from an older version.

In at least one embodiment, the tools include script notes configured for augmenting the script with metadata and a status parameter. In at least one such embodiment, metadata is attached to each script note and includes tags such as who added the note and when. It also determines what type of a note it is—an idea to consider, an error to be fixed, or a task to be completed. With regard to the status parameter, the present invention tracks various portions of the script and labels them with one of the following labels: new, under review, done, or rejected. A discussion over a script note can take place within the note through adding replies in a similar manner to an instant messaging chat, with the members discussing the notes back and forth as needed. It is possible to configure the revision approval rules, requiring one or more of specific members to approve revisions, either individually for each change, or on a scene level, or a full script level, with different approval rules for each level. In at least one embodiment, once a note is deemed “done,” it is archived so it can still be accessed, but it is hidden by default, in order to avoid confusion and clutter.

In at least one embodiment, the tools include a script versioning tool. In addition to the drafts created by the writers (with or without collaboration with the director and or producers), there is also the script versioning done by the script supervisor during filming, marking diversions from the written script as they happen from one take to the next, as well as changes made last minute on set, decided between the director and actors. This type of versioning is not saved as a whole separate draft, but rather as part of the script supervisor report and the metadata generated from it. Similarly, during post-production, additional changes may occur, through editing, ADR and VO recordings, as well as through reshoots and additional photography. Those updated versions can later also be used to assist with creating the closed captions for the film, as well as translations to other languages.

In at least one embodiment, the tools include one or more of animated floorplans, two-dimensional storyboarding and animated three-dimensional previsualization tools to aid in planning and communicating complicated scenes and/or shots in the shot-list.

In at least one embodiment, the tools include notes and questions by creative and production team members that can be attached to the script and/or shot-list (depending on context), making them better organized and thus more easily manageable. This might sound like a minor thing, but it can make a major impact on the creative collaboration process, because it makes it casier for team members to communicate with each other more effectively and efficiently, especially during production, when the often stressful schedule causes many important questions to remain unasked. This feature allows the person being presented with the questions (often the director) to tend to the questions relevant to what he or she is focusing on at the moment. In at least one embodiment, cach note or question added by a team member opens a private discussion between the team members, where they can add written replies, voice or video messages, or attach any relevant media. Additionally, in at least one embodiment, dialect coaches can add recorded example of the correct pronunciation of each relevant line in the script, accessible to the actor and other relevant team members, and the actor can add recordings (through the notes feature above) to be looked at by the dialect coach, for feedback on specific challenging lines the actor might be struggling with.

In at least one embodiment, the tools include a footage playback module configured for providing instant playback of footage uploaded as proxy by DIT, not only on desktop, but also on mobile devices of authorized production staff, casily located by being attached to the script and shot-list in the server 100 project, helping to keep continuity within a scene shot over multiple days. In at least one such embodiment, script supervisor notes can automatically import along with the footage into the editing bay as meta-data attached to the footage and to the project via a plugin provided by the server 100, API (“Application Programming Interface”), or other computer integration mechanism.

In at least one embodiment, the server 100 further includes a master schedule that is associated with the scheduling module 140 which includes a comprehensive list of all resources used in the project, the entity responsible for providing the resource, and the date, time, and location the resource is to be provided for filming, for example. As stated, resources include the script, actors, locations, equipment, props, costumes, to name a few.

In at least one embodiment, the server 100 further includes in it's scheduling module a scenario generator 150 which is configured to generate a plurality of potential schedules (referred to herein as “candidate schedules”). Each candidate schedule represents an alternative production schedule based on the availability of all the resources. Several candidate production schedules may be generated based on the different dates of availability of the principal actors, the filming location, and other resources, for example. The candidate schedules differ from one another based on the date and/or time of availability of one or more resources. A first candidate schedule may specify that a particular scene is to be shot on a Monday morning, for example, while a second candidate schedule prescribes that the scene is shot on a Friday afternoon at the end of the day. The alternative candidate shots may then be compared based on the financial impact on the budget, as described in more detail below. The candidate schedules may encompass the entire project or a portion of the project. That is, the candidate schedules may set forth a comprehensive schedule until filming is complete, or a portion of the filming to be completed in the coming week or other pre-defined period of time selected by the producer, for example.

In at least one embodiment, the server 100 further includes a cost estimator in the budgeting module 160 including a list of cost rules 162 and union pay rules 164, for example. The cost estimator is configured to generate a budget for each candidate schedule based on the set of cost information set forth in the cost rules 162 and pay rules 164. The cost rules may include, for example, the daily cost to rent a sound stage while the pay rules prescribe how cast and crew members are to be paid based on the numbers of hours worked in a day, a week, on the weekend, or while away from their local region.

In deciding to make a project signatory with one guild or union or another, one of the critical aspects is the question of under which agreement will the project become signatory with the union. For example, SAG-AFTRA has their student film agreement, short film agreement, new media agreement, micro-budget agreement, ultra-low budget agreement, modified low budget agreement, low budget agreement, and full budget theatrical agreement, and that's just for film. There is a whole set of agreements for television, film, stage productions, etc. All the short and low-budget flavors, each has a total budget limitation, determining a project's eligibility to become signatory under that agreement. Each agreement brings a different set of rules and minimum compensation rates, and in some cases, even different amount of maximum number of hours of work per day and days per weck, that the performers may be required to work, and a minimum number of hours between the end of the work of a performer in one filming day and the time they are required to report to set for the beginning of the next. Accordingly, in at least one embodiment, upon hitting a union threshold in the total budget while planning a project, the system is configured for both alerting the producer of the issue, and offering to recalculate the budget according to the higher rates. On the other hand, if the budget is close to a lower threshold, the system will alert the producer, that by cutting a calculated amount from the total budget according to the current rates, they can save an additional amount through utilizing the agreement that uses lower rates.

A similar example would be the Directors Guild, which similarly has several budget levels that correspond with different compensation levels to the director, but also, in case the total budget is under a certain threshold (currently about $2.5M), there are no minimums imposed by the guild, and the producer is free to negotiate with the director as low as they want; which means that for lower budget projects, being signatory with the director's guild isn't likely to affect the production cost. That said, on bigger budgets, not only are there minimum rates imposed, but residuals are owed as well, and that is also calculated by the system in at least one embodiment.

In at least one embodiment, the server 100 is also configured to alert the producer about missing scheduling information and/or cost information prior to generating a candidate schedule. If necessary, the producer can populate the data with initial estimated figures, which are flagged as unconfirmed estimates until they are updated or confirmed by the member in charge of associated resource. Referring to the example above, shooting a particular scene on a Monday morning may delay the film's completion date, which has a cost associated with it. By contrast, shooting the same scene on Friday afternoon may entail payment of overtime, which also involves a financial impact on the film production cost. The cost estimator module 160 is configured to estimate the cost of each candidate schedule so that the producer can easily compare and choose a schedule that minimizes the cost of production.

In at least one embodiment, the server 100 further includes a communications module 170 configured to generate notifications and messages, for example, when a change in filming schedule is being considered. In at least one such embodiment, when a change in the schedule is selected as a candidate schedule, or otherwise confirmed by the producer, for example, the communications module 170 is configured to determine which resources are affected and then communicate the relevant changes to the parties responsible for those resources. In some cases, when information about some of the resources' availability is missing, before officially confirming the new schedule, the communications module 170 requests confirmation from the recipients that the change in schedule is acceptable.

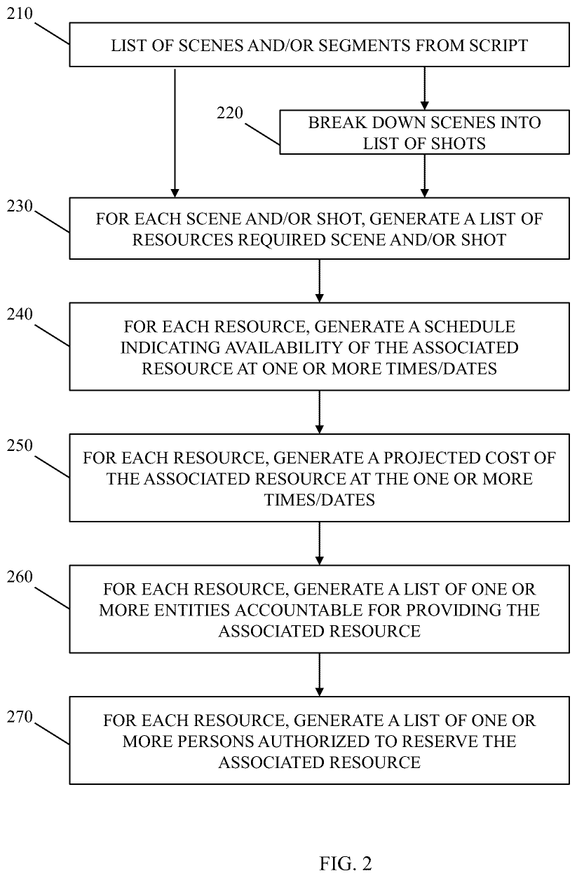

FIG. 2 is a flow diagram of an exemplary method for generating an initial schedule and budget from a script, in accordance with at least one embodiment. In at least one embodiment, the writers first either upload a script to the server 100 or draft the script from scratch within the environment created by the server 100. Depending on the type of script, the script generally comprises a series of scenes or segments 210. The creative team (typically the director and the director of photography) would create a shot list breaking down a scene to a plurality of shots 220, referred to generally herein as the “scene” for simplicity purposes. The scene or shot list includes a detailed plan indicating the sequence of scenes to be filmed (or simply acted, in situations where the script is for a live production, such as a play for example). In most cases there is at least one, and often multiple shots for each scene. In some cases, a single shot may go across two or more scenes. For example, following a character from inside a house to the street, then into a car. The “INT. HOUSE—DAY” would be a separate scene from “EXT. STREET—CONTINUOUS”, and the “INT./EXT. CAR—CONTINUOUS” scene, but they might be all covered by a single continuous shot (often referred to as a “oner”). Such multi-scene shots may be as simple as following a character from the living room to the kitchen, or as complex as covering entire sequences of multiple scenes in a film. In either case, the entire script is associated with a number of scenes and/or shots that are listed and recorded in sequence by the server 100.

In at least one embodiment, for each scene and/or shot in the script, the server 100 generates a list of resources required for production of the scene/shot (230). The resources are then associated with the scene/shot in memory on the server 100. The list of resources associated with the scene/shot include one or more of the actors in the scene/shot, props used in the scene/shot, costumes used in the scene/shot, the location or locations where it is to be filmed, people involved, etc. The list of resources then serves as a form of checklist that must be acquired prior to filming. For example, if there is a rehearsal, the approved version of the script, as well as the rehearsal space (be it the actual filming location, the production office, or a dedicated rehearsal space), the director (and/or choreographer, stunt coordinator, music director, vocal coach, etc.), and performers, all need to be available. This also applies to post-production tasks. For a certain scene to be edited, it must be filmed first. For some visual effects, some assets must be created or acquired first. Often, such assets must be filmed specifically for the project.

In at least one embodiment, for living resources, scripted characters are added automatically. For example, in a narrative screenplay, characters that have dialogue lines in the script are added automatically, and non-speaking characters need to be manually added, as described further below. As another example, in a loose script format, the list of characters is listed as part of the loose script. In at least one embodiment, additional types of resources, including non-speaking characters in a scene, are added as described below. In at least one embodiment, upon a resource being added to a given scene, the user is presented with an at least one dropdown menu (or other suitable graphical user interface, now known or later developed) with selectable options that are tailored to each type of resource. For example, in at least one embodiment, where the resource to be added is part of the cast, the interface opens a list of characters that have been established in the script and will allow the user to add any new characters that aren't automatically added (such as non-speaking characters), which will add the new character to the list, for the next time it needs to be added. As another example, in at least one embodiment, where the resource to be added is part of the performers/talent, the interface allows for the addition of hosts (listed as their actual name, with the attribute of a host/judge/etc.), guests (listed as their own name with the attribute of an interviewee, panelist, contestant, etc.—this type would often be a non-member resource, and can even be a compound resource, in case of, for example, a musical guest that is a band), body doubles (which opens a list of character to choose from, similarly to how it is done when adding cast, but this connects not to the main cast of actors, but instead, to a cast of body doubles), stunt doubles (which opens a list of character to choose from, similarly to how it is done when adding cast, but this connects not to the main cast of actors, but instead, to a cast of body doubles), stunt performers (allowing for the specification of attributes such as type of stunt specialty, which stunt it is related to, with each stunt being its own non-human resource in the form of an embedded loose-script format, and which role within the stunt, casting the roles within the embedded stunt script), motion capture performers (allowing for the specification of attributes such as type of specialty and role(s) within the motion-capture embedded script), ADR and voice-over performers (allowing for the specification of attributes such as language(s) and/or specialties, and role(s) within the ADR embedded script), and musicians (allowing for the specification of attributes such as instrument(s), musical genre(s), on-camera or recording only and, if on-camera, casting-call characteristics such as gender, race, age-range, height, etc.). As yet another example, in at least one embodiment, where the resource to be added is part of the crew, the interface the interface opens a list of crew members that have been established in the script and will allow the user to add any new crew members that aren't automatically added, which will add the new crew member to the list, for the next time it needs to be added. In at least one embodiment, individual crew members can be removed on a scene-by-scene basis. For example, if sound doesn't need to be recorded for a given shot, the sound recordist and boom operator don't need to be there. In at least one embodiment, when adding crew members as resources to a scene, it is for crew members that are needed for specific scenes, such as stunt coordinator, fight choreographer, choreographer, animal wrangler, steadicam operator, drone operator, dolly grip, special effects supervisor, visual effects supervisor, armorer, on-set teacher (for child actors), COVID compliance, and union representative (for scenes including nudity). In at least one embodiment, where a given project is comprised of a plurality of project units, with cach project unit consisting of its own set of crew members, production team, creative team, etc., by assigning a scene to a given unit (for example, 1^{st} unit, 2^{nd} unit, promo BTS unit, etc.) the core members of that unit (such as the director, cinematographer, 1^{st} AD, script supervisor, etc.) are automatically added.

In at least one embodiment, for cach resource associated with a scene or shot, the server 100 generates a schedule indicating the availability of the resource (240). The availability can include at least the dates that the resource is available to the film project, but may also include the times of day that it's available as well. In most cases, the project will not need or require such availability information. If and when the film schedule must be revised, however, the collection of availability information for the relevant resources can be essential to quickly and accurately deciding how to reschedule the filming to accommodate changes in availability of resources. After all, the absence of even one resource on the day a shot is to be filmed can cripple the production and can cause massive financial consequences.

In at least one embodiment, based on the data regarding the availability of all the required resources, the server 100 generates an estimate of the cost of the resource at different periods of time that it is available (250). For example, an actor may be available for several days in addition to the day they are scheduled to film a scene. The cost may, for example, be governed by the actor's contract or may be a per diem cost prescribed by a union. In either case, the costs for alternative availability is entered in the server 100 or otherwise calculated by the server 100.

In at least one embodiment, in addition to the availability and costs of all the resources, one or more entities responsible for providing each resource is entered, recorded, or otherwise uploaded to the server 100 (260). The entity may be a person or corporate entity, for example, responsible for making or delivering the resource when and where it is needed for the film project. In at least one such embodiment, in addition to the identity of the person or entity, all relevant contact information for that person or entity is provided to the server 100. In at least one embodiment, in the event the shot schedule changes, it is this person or entity that must be contacted in order to arrange and confirm a new reservation date and/or new delivery date.

In at least one embodiment, in addition to the one or more persons/entities responsible for a resource, the server 100 also retains the names of one or more persons that are authorized to change or otherwise modify the reservation for each resource (270). The producer and a department head, for example, are by default authorized to request, reserve, and modify reservations for all resources associated with a scene or shot. A prop master, for example, can have the authority to decide which props to purchase/rent and the authority to make and modify the reservations for all prop resources.

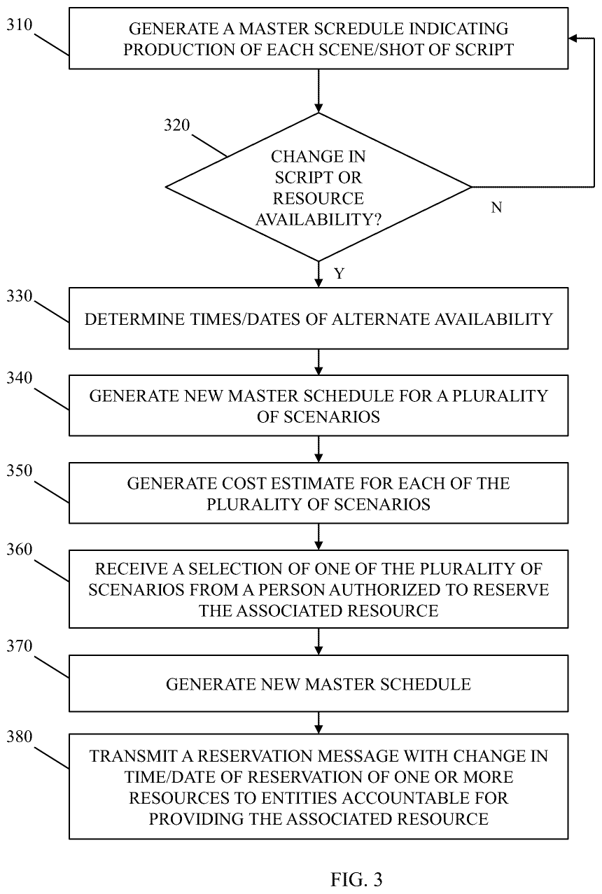

FIG. 3 is a flow diagram of an exemplary method for updating a schedule and cost estimate based on some form of change in the script, scheduling, or availability (for example, in the event a resource is no longer available, or in the event a new scene is added to the script, or in the event a new resource is added to a scene, etc.), in accordance with at least one embodiment. In at least one embodiment, prior to the change, the server 100 generates a master schedule indicating the time and date that every scene and/or shot of the script is to be filmed, or at least the time and date that every scene and/or shot of the script is to be filmed in the coming days, weeks, or months (310). In at least one embodiment, the master schedule is determined with the input of producer. As discussed above, in at least one embodiment, the master schedule is determined based on the availability of all the resources needed for the film production.

In at least one embodiment, in the event there is a change in the script that affects the need for certain resources (such as a scene being cut out of the script, or a character being added to a scene, or a scene taking place in a different location, for example), or a change in the availability of a resource, the decision block (320) is answered in the affirmative. For purposes of this application, a significant change in the script may include revisions that require new scenes or shots be filmed, or fewer scenes or shots be filmed. A significant change in resources generally refers to a resource that is no longer available when a shot is to be filmed, thus requiring to reschedule the shot to be changed accordingly, or find another workaround that will no longer require the missing shot if that shot is no longer possible to pull off. In at least one embodiment, the script writing and editing module 130 provides a thread tracker configured for linking multiple scenes having related resources. Thus, in at least one such embodiment, upon a given scene being deleted from the script, the thread tracker is configured for alerting the user if the deleted scene is part of a thread, and notifies the user of the other parts of the thread, to make sure the removal of the deleted scene doesn't break the thread.

In at least one embodiment, to initiate a change in the schedule, the server 100 identifies times and dates of availability to film one or more new scenes or shots (330). In at least one embodiment, for each new scene or shot, all the required resources must be available on the same day or during the same time period. These resources will include actors, location, props, costumes, crew members, etc. If more than one date and time is available, the server 100 generates a plurality of schedules, each schedule being an optional candidate schedule from which the relevant production team member(s)-typically first assistant director, director, producer, and production manager, for example-can choose (340). Each of these candidate schedules represents a complete and comprehensive schedule for the filming of the entire film production on a scene-by-scene and/or shot-by-shot basis.

In at least one embodiment, the server 100 then uses the cost rules to estimate the cost of production for each of the plurality of candidate schedules, cach candidate schedule corresponding to a different film scenario (350). The term “scenario” as used herein refers to a candidate schedule and the associated budgetary costs. As discussed above, in at least one embodiment, the cost estimate for each candidate schedule is based on the number of days of filming, the number of hours of filming, the cost per hour of filming, and the cost for actors, crews, location, props, costumes, etc. It also takes into account required preparations that need to be scheduled and paid for, such as rehearsals, special makeup that needs to be applied on the day of filming, and, as we see since 2020, mandatory medical tests (such as COVID-19 testing) in specified times prior to the filming day. In at least one embodiment, the different candidate schedules and their associated cost estimates are presented to the relevant production team member(s). To make a selection, the decision maker selects a candidate schedule and the selection is received by the server 100 (360).

In at least one embodiment, the selected candidate schedule is then used by the server 100 to generate a master schedule and at least parts of that master schedule published for the members (370). In the master schedule, all the resources are reserved in accordance with the scene or shot list defined in the selected candidate schedule. In at least one embodiment, where the resource pertains to a person or animal (hereinafter referred to as a “living resource” for simplicity purposes), the server 100 generates a “call sheet” identifying those living resources that need to be present on one or more days of filming. To the extent that any resource reservations are changed from the prior schedule, the server 100 transmits new reservation messages for all the resources needed to complete the scene or shot list as prescribed by the master schedule (380). In at least one embodiment, in addition to new reservations, the server 100 may unreserve resources that are inconsistent with the new master schedule. The new reservations are then transmitted to the parties responsible for those resources and, if necessary, confirmation of receipt of the new schedule requested.

In at least one embodiment, the server 100 is specifically adapted to assist in the planning, managing, casting, and crewing of live theater and music concert tours, as well as other types of live shows and events utilizing scripts, casting and crewing tools, as well as scheduling and project management tools described herein. In at least one such embodiment, the server 100 is configured to support employment of local talent for music tours—i.c., hire people local to the geographic location of performance. In the case of a concert tour, for example, local talent may be necessary for any number of different geographic locations at which the concert or theater is performed. In the case of live theater, for example, the cast may be rotated in order to utilize alternates, understudy performers, and local performers while changing venue from location to location. In such live show implementations of the system, each date of performance is treated in a similar manner to a filming day. Unlike with a film project, however, the entire primary script is performed in full on each showing (sometimes more than once per day), and the “scenes” are not marked as “done,” as they need to be performed each time anew. On the other hand, the rehearsal schedule tends to be more elaborate for live shows, so the project management algorithm is implemented slightly differently for live shows and events, and the member roles in such projects have different titles. The principles of the system in such embodiments, however, remain the same.

With respect to all type of filming and production (not just live theater and music concert tours), when filming locations or other functions related to the project are not geographically local to one or more of the members or non-members of the project who need to be on set or otherwise perform an in-person function in the production, and/or when filming locations are far enough from one another (different countries, or, depending on union localities and/or distance, even different counties, Travel Days are scheduled and budgeted for, as well as other appropriate accommodations, such as hotel rooms and appropriate per diem payments are budgeted for.

The locality of filming locations and other project related in-person functions, is taken into consideration when scheduling and budgeting. Travel management, including getting people and other resources from where they are to where they need to be (for example, from the hotel to the set for filming, or from home to the airport), can also be coordinated from within the system.

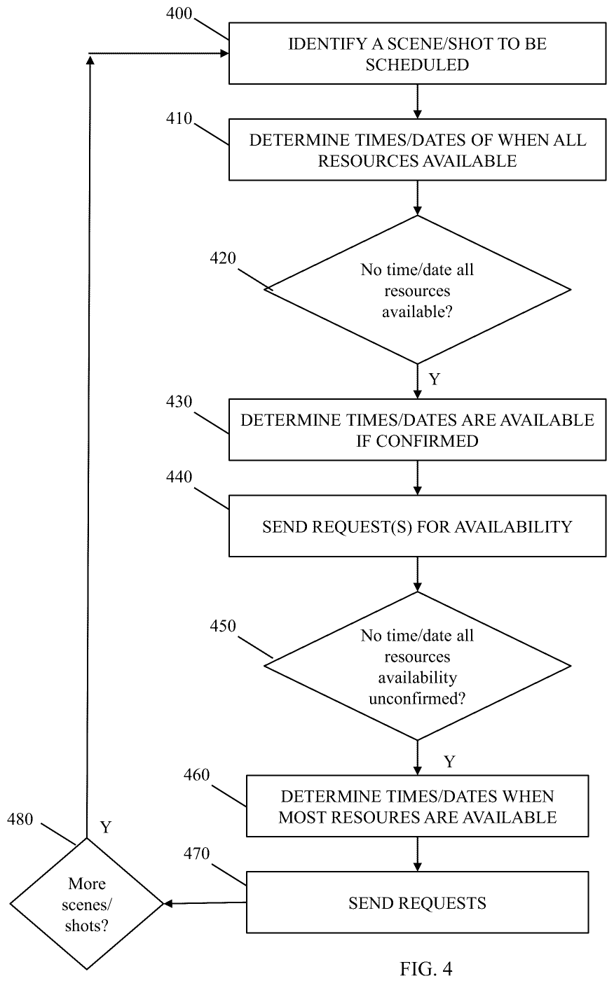

FIG. 4 is a flow diagram of an exemplary method for identifying a candidate schedule, in accordance with at least one embodiment. In at least one embodiment, the server 100 first identifies a first scene/shot to be filmed and retrieves all the resources required for the scene/shot (400). The server 100 then attempts to identify a time/date that all the required resources are available based on the availability data uploaded to the server 100 (410). In at least one embodiment, in the event the server 100 is unable to identify a time/date in which all the resources are available, decision block (420) is answered in the affirmative. FIG. 4 relates to film implementation as described herein, but will vary when applied to live shows, live broadcasts, live entertainment events, theater projects, and other projects that do not undergo editing and post-production, for example. As is known, scheduling and budgeting of live events are different because they are performed live and in full each time the event is performed (as opposed to filming a film project where the schedule prescribes which shots and portions of the script are filmed cach day and how they are assembled in editing and post-production). These differences in scheduling and budgeting are also supported by further embodiments of the system described herein.

In at least one embodiment, as a second attempt, the server 100 attempts to identify a time/date that all the resources are potentially available (430). In at least one embodiment, a resource is potentially available if it is not confirmed to be unavailable, even if its availability is not yet confirmed by the server 100. In this case, the server 100 attempts to identify a time/date that all the resources are not known to be unavailable (430) and then confirms their availability by sending a request to the person/entity responsible for scheduling those resources (440). In some cases, the server 100 is unable to identify a time/date in which all the resources are potentially available, in which case decision block (450) is answered in the affirmative.

In at least one embodiment, as a third attempt, the server 100 attempts to identify a time/date that most of the resources are available or potentially available, even if some are confirmed to be unavailable (460). For those resources that are unavailable, the server 100 attempts to request a change in availability by sending a request to the person/entity responsible for scheduling those resources (470). If this person/entity can change or otherwise reschedule the resource(s), the server 100 is able to incorporate this change into the candidate schedule.

In at least one embodiment, the process described above is repeated for each scene/shot for a predetermined period of time equal to a day, week, month, or the entire project. If there are more scenes/shots to be scheduled, the decision block (480) answered in the affirmative and the process is repeated for the next scene/shot.

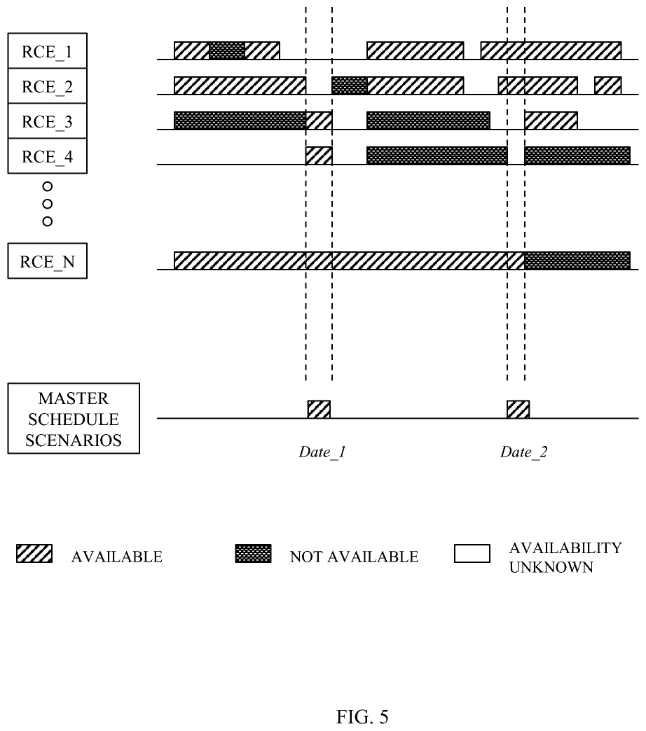

FIG. 5 is an illustration of a plurality of exemplary schedules for identifying a candidate schedule, in accordance with at least one embodiment. As shown, schedules are shown for resources 1 through N. Each of these resources is required for a single shot or scene, for example. Each resource, in turn, is associated with a schedule that indicates the availability of the associated resource. The first resource (“RCE_1”) has times that the resource is clearly available and reservable, unavailable and unresolvable, and unreserved and potentially available. In at least one embodiment, when identifying candidate schedules, the server 100 is configured to identify dates and/or times when all the required resources are either clearly available or potentially available. Based on the exemplary resource availability illustrated in FIG. 5, there appears to be two candidate schedules available. In the first candidate schedule, the scene may be shot on “Date_1.” In the second candidate schedule, the scene may be shot on “Date_2.” If and when the producer selects and approves one of these options, the server 100 is configured to generate a master schedule indicating the date and times for filming all or some of the scenes/shots on the scene or shot list, generate call sheets for crew members, and transmit reservation messages to reserve all the resources required for the scene on the date indicated on the candidate schedule.

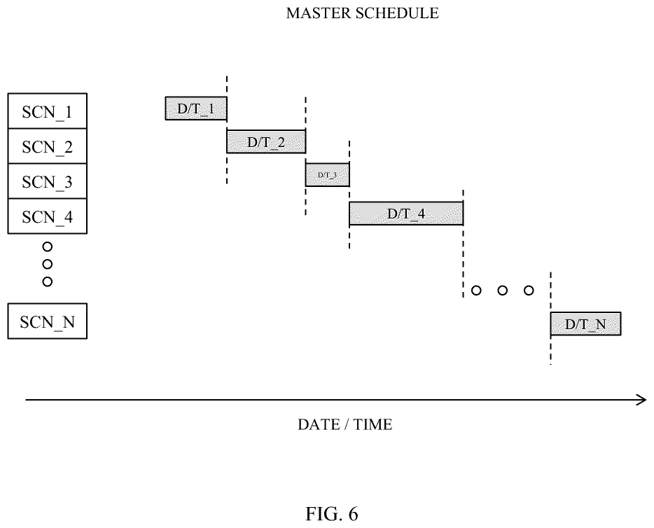

FIG. 6 is an illustration of an exemplary approved production schedule in the form of a Gantt chart, listing the date and time for all the scenes and/or shots, in accordance with at least one embodiment. In at least one embodiment, each scene/shot is assigned a unique date and time to be produced. All the scenes/shots are represented in the Gantt chart, although the order in which they are shot may be out of sequence with respect to the order in which they appear in the script. In at least one embodiment, if and when the master schedule is changed or otherwise updated by the server 100, the date and timing of some if not all the shots are changed or modified by the server 100 as well. In some embodiments, the Gantt chart is limited to one or more resources. A Gantt chart may be used, for example, to manage the production of a song in a musical as well as the rehearsals for that song, the production of a set as well as the dressing of the set, and scene that needs to be shot before editing can begin.

In at least one embodiment, the server 100 may include a number of other features and functions as well. For example, in at least one embodiment, the server 100 may include a scene or shot list that includes details for each shot in a given entertainment product, such as how the shot is created, and how the shot interacts with the script and with the rest of the system, whether the shot is a practical shot or a composite shot, whether the shot is a shot that spans across multiple scenes, and whether shooting a single scene in multiple locations may cause different shots belonging to the same scene, to be assigned different locations, dates and resources. In at least one embodiment, the server 100 may also include a script breakdown. In at least one embodiment, the server 100 may also include details on parallel activities of cast and crew members, including but not limited to crew setting up the next shot while the rest are still filming the current scene, crew taking carly lunch and then setting up the next shot of the same scene while others are in lunch, crew starting a company move while the rest are still filming, the set for a later date is being built and dressed while the main production crew is filming other scenes, a second unit is filming while a first unit is also filming. In at least one embodiment, the server 100 may also include details on union (and legal) scheduling rules and how the system uses them, including but not limited to break for lunch within 6 hours, allotting enough hours for sleep between wrapping a filming day and the call-time for the next day, minors (i.c., actors under the age of majority, such as 18) can only work for 6 hours per day, and SAG-AFTRA members get a higher pro rata rate for overtime (there is “time-and-a-half,” “double-time,” and “golden hours,” depending on the type of production and budget level, as well as day of the week and how many filming days in a row are required, and no more than six in a row are allowed). In at least one embodiment, the server 100 may also include first A.D. tools, including but not limited to marking wrapped shots and scenes as done, marking cancelled or consolidated shots, time management tools on the day of filming (such as real-time alerts for scheduled parts of the day, real-time alerts for union required lunch breaks and end-of-day per member, real-time alerts for cast and crew overtime, and system suggestions for possible scenarios to consider, in case of falling out of schedule, or being unable to comply with union rules and penalty calculations), and timeline views (per hour and per day) with each member being represented on their own line (with filters for easy access to various types of members based on category, such as main cast, background performers, camera crew, makeup, etc.). In at least one embodiment, the server 100 may also include details on character names and cast attached to them (in script breakdown). For example, in at least one such embodiment, one character can have multiple names in the script and still refer to the same character via an “alias” feature. As another example, one character with one name may be split between multiple performers. This is in order to accommodate situations such as vastly different ages being played by different actors (c.g., boy, a teenager, a middle aged man, and an old man), or two minor twins alternating, in order to overcome child labor laws that limit filming times with minors to six hours, and enable longer days of filming. As another example, multiple characters might be played by the same actor. In case the same actor is playing multiple characters in the same scene, the system 100 will know it is only one performer, even though the performer is attached to multiple characters in the same scene, and calculate resources accordingly.

In at least one embodiment, a project may include multiple, different types of scripts in addition to the primary script (principal photography) discussed above. For example, the project my include (a) pick-ups and reshoots, (b) automated dialogue replacement (“ADR”) and voice overs, (c) embedded scripted elements, and (d) promotional and public relations (“PR”). Pick-ups and reshoots are revised and/or parts of the script that are added at a later date. Pick-ups and reshoots are generally shot after the end of principal photography. ADR and voice over refers to parts of the script that do not need to be visually filmed, but rather recorded as audio only. In some cases, those are included in the primary script. For the purposes of the audio recording, those may be included in a dedicated ADR script and may be formatted differently than the primary script and/or split into numbered lines for organizational purposes. Embedded scripted elements are portions of script that aren't fully included in the primary script. A common application in film would be a mock TV show playing in the background of the main scripted scene. Such a scripted TV show would not typically be fully scripted inside of the primary script, but will still need to be produced as its own mini-movie, embedded inside of the primary one. This often calls for a separate script which needs to fit in the overall budget and schedule. Promotional and PR are scripted and unscripted elements produced for promotional purposes, be it for social media presence, media interviews, trailers, and behind the scenes featurettes. These types of scripts are “resources” in the server 100 and are, therefore, accounted for and planned into the production schedule and budget. In such embodiments, all of these alternate forms of scripts are bundled into the overall project and are included in its budget and schedule.

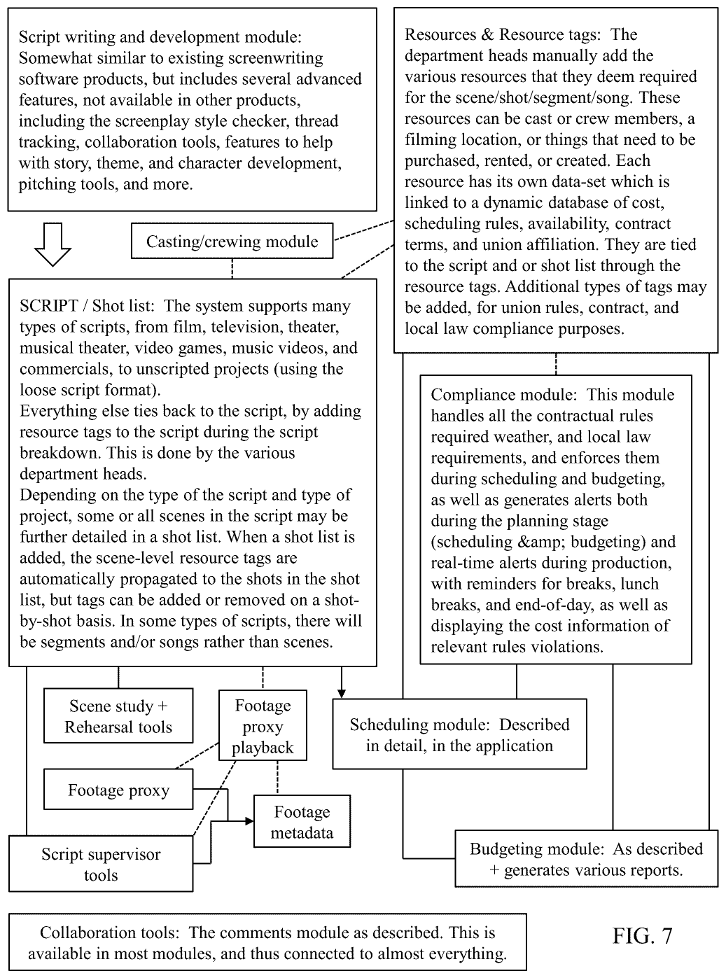

FIG. 7 is a flow diagram of an exemplary a system and associated methods for developing, writing, and managing entertainment projects, in accordance with at least one embodiment. This is exemplary of the system and not all modules are shown. There is at least one script writing and development module, at least one script/shot list, at least one casting and crew module, at least one compliance module, at least one scheduling module, at least one budgeting module, and resources and resource tags.

The script writing and development module is described in detail above. It is somewhat similar to existing screenwriting software products, but includes several advanced features, not available in other products, including the screenplay style checker, thread tracking, collaboration tools, features to help with story, theme, and character development, pitching tools, and more.

The script/shot list is described in detail above. The system supports many types of scripts, from film, television, theater, musical theater, video games, music videos, and commercials, to unscripted projects (using the loose script format). Everything else ties back to the script, by adding resource tags to the script during the script breakdown. This is done by the various department heads. Depending on the type of the script and type of project, some or all scenes in the script may be further detailed in a shot list. When a shot list is added, the scene-level resource tags are automatically propagated to the shots in the shot list, but tags can be added or removed on a shot-by-shot basis. In some types of scripts, there will be segments and/or songs rather than scenes. Because there are so many different types of tags and comments attached to the script, the front end offers easy filtering of the tags based on usage context, so that only the relevant comments are visible in each situation. For example, if the director looks at a scene, he might focus on scene study comments for a particular character, rehearsal notes, visual design comments, questions from cast and crew, etc.

The casting and crew module is described in detail above.

The compliance module is described in detail above. This module handles all the contractual rules required weather, and local law requirements, and enforces them during scheduling and budgeting, as well as generates alerts both during the planning stage (scheduling & budgeting) and real-time alerts during production, with reminders for breaks, lunch breaks, and end-of-day, as well as displaying the cost information of relevant rules violations.

The schedule module is described in detail above.

The budgeting module is described in detail above. The resources and resource tags are described in detail above. The department heads manually add the various resources that they deem required for the scene/shot/segment/song. These resources can be cast or crew members, a filming location, or things that need to be purchased, rented, or created. Each resource has its own data set which is linked to a dynamic database of cost, scheduling rules, availability, contract terms, and union affiliation. They are tied to the script and or shot list through the resource tags. Additional types of tags may be added, for union rules, contract, and local law compliance purposes-this could be considered part of the compliance module as well.

Additional features/functionality include scene study and rehearsal tools as described above, footage proxy and footage proxy playback as described above, footage metadata as described above, script supervisor tools as described above, and collaboration tools as described above.

The system can filter out/hide elements that irrelevant to the function being performed based on the use context. Stated another way, based on the user and the task the user is performing, only relevant elements/modules attached to the script will be accessible/viewable the user. For example, the producer will not be able to view private communications between individuals. Or, for convenience, the director (who has access to many modules and departments) would not have to view all notes associated with a scene and instead would only view the relevant notes to the module he is working on/within.

It should be noted that the various modules (casting/crew module, compliance module, scheduling module, budgeting module and resource module) can connect to third party systems to pull and send necessary information.

### EXAMPLES

The following non-limiting examples are provided for illustrative purposes only in order to facilitate a more complete understanding of representative embodiments now contemplated. These examples are intended to be a mere subset of all possible contexts in which the system may be utilized. Thus, these examples should not be construed to limit any of the embodiments described in the present specification. Ultimately, the system and associated methods may be utilized in virtually any context involving the development and management of entertainment projects.

An actress named Laura is a member in a project, but per her and her manager's preference, it is Laura's talent manager, Cindy, responsible for managing her schedule during production. While Laura would be notified of schedule changes, Cindy is the authorized member responsible for confirming Laura's availability on the server 100.

Also, Laura is a member of the Screen Actors Guild (“SAG-AFTRA”). Based on the project's budget level, there is a set of rules dictating how many hours she may work each day, how many days in a row she may work, and how many hours off at a minimum she needs to be allotted before her call time the following day. The union rules also dictate how many hours in a row she may work before breaking for lunch, as well as the minimum duration of that lunch break. If production needs her to work longer, the union rules will dictate an increased compensation for those additional hours, and may also charge the production penalties. All of those rules cover all of the performers in the production who are members of the union. As a result, the resource associated with the performers would be associated with a union and their “union status” would be identified as a “SAG-AFTRA member.” This will connect the resource named “Laura” with the database representing the relevant union rules.

Laura has been cast to shoot “Scene 34” of the script which takes place in a set of a spaceship. That spaceship set needs to be created first, constructed in the sound stage, and then dressed (the process is called “set dressing”). Then, and only then, can the scene be lit and shot. This means that the resources for that scene include the actors, film crew, sound stage, lighting and grip equipment, and the spaceship set. That spaceship set is obviously a “NON-MEMBER RESOURCE” since it is not even a person. The member assigned to determine its availability may be the production designer or someone from his or her team.

There are also several steps in the process of creating that spaceship set. The set must be designed, constructed, painted and/or textured, and dressed. The graphics on the video screens in the set also needs to be prepared ahead of time, if it is to be filmed practically in-camera rather than being added later as a visual effect. Each step can only be scheduled to take place after the previous step has been completed. Using the time estimates of each production team member who is responsible for each of those steps, the server 100 can determine how long it should take for that set to be ready for filming, and thus, determine the earliest date that the set, as a resource, would be available for filming. The server 100 will also prevent (or rather warn against) anyone scheduling of “Scene 34” before the set is scheduled to be available and ready for filming (although a warning can be overridden manually to enable, for example, a portion of the set that is ready to be used for filming while avoiding the unfinished portion of the set.). Additionally, on the level of project management, it will allow each of the crew members (also members of the server 100) to know when they can expect to begin work on their part in creating the set, and when they are expected to finish their part and hand it over to the next phase of creating the set (or for the last phase, when it needs to be ready for filming).

Aspects of the present specification may also be described as the following embodiments:

1. A method for managing entertainment production resources and dynamically generating production schedules and production budgets based on an availability of said resources, the method comprising the steps of: implementing a server configured for receiving and processing data related to a plurality of members associated with an at least one entertainment production and a plurality of resources associated with the at least one entertainment production; implementing a master schedule module in memory on the server, the master schedule module configured for storing the data related to the members and resources associated with the at least one entertainment production; implementing a scenario generator in memory on the server, the scenario generator configured for generating a plurality of candidate schedules for the at least one entertainment production; implementing a cost estimator module in memory on the server, the cost estimator module configured for generating cost estimates for each candidate schedule based on a set of cost details accessible by the server, said cost details including at least one of a general cost rule or a union pay rule; and upon a new entertainment production being added to the master schedule module: the master schedule module receiving a scene or shot list containing a plurality of planned scenes for said entertainment production; for each planned scene in the scene or shot list: the master schedule module generating a resource list containing each of the plurality of resources associated with said planned scene; and for each resource in the resource list: the master schedule module generating a resource schedule containing an at least one resource availability for said resource, each of the at least one resource availability being a date and time at which said resource is currently available to be used for said entertainment production; and the cost estimator module generating a resource cost for each of the at least one resource availability in the resource schedule based on the set of cost details accessible by the server; the scenario generator generating an at least one candidate schedule containing each of the resources in the scene or shot list, based on the resource availability associated with each of said resources along with an at least one resource rule associated with each of said resources; for each of the at least one candidate schedule, the cost estimator module generating a total schedule cost for said candidate schedule based on an aggregate of the resource cost associated with the resource availability for each of the resources in said candidate schedule; the master schedule module selecting a one of the at least one candidate schedule; the master schedule module establishing a resource reservation for each of the resources based on the resource availability for each of the resources in said selected candidate schedule; and the master schedule module generating a master schedule containing each of the resource reservations for said entertainment production.

2. The method according to embodiment 1, further comprising the step of, upon the master schedule module determining the absence of data in the resource schedule associated with a given resource for a given planned scene, or an absence of data in the set of cost details accessible by the server, the master schedule module transmitting an alert notification to a producer of the associated entertainment production.

3. The method according to embodiments 1-2, further comprising the step of, for each resource in the resource list for a given planned scene, the master schedule module storing a resource provider containing select contact information for an at least one entity responsible for providing said resource.

4. The method according to embodiments 1-3, further comprising the step of, for each resource in the resource list for a given planned scene, the master schedule module storing an at least one authorized member associated with said entertainment production and having the authority to modify the at least one reservation associated with said resource.

5. The method according to embodiments 1-4, further comprising the step of the master schedule module distributing select portions of the master schedule to the members associated with said entertainment production.

6. The method according to embodiments 1-5, further comprising the step of the master schedule module generating a call sheet for each planned scene for said entertainment production, said call sheet containing details related to each resource associated with said planned scene that is a living resource.

7. The method according to embodiments 1-6, wherein the step of the scenario generator generating an at least one candidate schedule further comprises the steps of: for each planned scene in the scene or shot list: the scenario generator obtaining the resource list associated with said planned scene; for each resource in the resource list, the scenario generator obtaining the at least one resource availability associated with said resource; the scenario generator identifying at least one resource availability that is common amongst each of the resources in the resource list associated with said planned scene; and the scenario generator adding said identified at least one resource availability to the at least one candidate schedule.

8. The method according to embodiments 1-7, further comprising the steps of: for each planned scene in the scene or shot list: upon the scenario generator determining that no resource availability exists that is common amongst each of the resources in the resource list associated with said planned scene: for each resource in the resource list, the scenario generator determining an at least one potential resource availability associated with said resource, said at least one potential resource availability being a date and time at which said resource is not currently unavailable to be used for said entertainment production; the scenario generator identifying at least one of a resource availability or potential resource availability for each of the resources in the resource list associated with said planned scene that is common amongst each of the resources in said resource list; upon the scenario generator confirming the identified resource availability or potential resource availability for each of the resources in said resource list, the scenario generator adding said identified at least one resource availability or potential resource availability to the at least one candidate schedule; and upon the scenario generator determining that no resource availability or potential resource availability exists for one or more resources that is common amongst each of the resources in the resource list associated with said planned scene, the scenario generator requesting a change of resource availability with respect to said one or more resources.

9. The method according to embodiments 1-8, wherein the step of the master schedule module selecting a one of the at least one candidate schedule further comprises the step of the master schedule module selecting the candidate schedule having the lowest total schedule cost amongst the at least one candidate schedule.

10. The method according to embodiments 1-9, wherein the step of the master schedule module generating a master schedule further comprises the step of the master schedule module generating a master schedule as a Gantt chart containing each of the resource reservations for said entertainment production.

11. The method according to embodiments 1-10, further comprising the steps of, upon the scene or shot list of a given entertainment production being revised: the master schedule module receiving the revised scene or shot list containing a plurality of planned scenes for said entertainment production; for each planned scene in the revised scene list: the master schedule module generating a revised resource list containing each of the plurality of resources associated with said planned scene; and for each resource in the revised resource list: the master schedule module generating a resource schedule containing an at least one resource availability for said resource, cach of the at least one resource availability being a date and time at which said resource is currently available to be used for said entertainment production; and the cost estimator module generating a resource cost for each of the at least one resource availability in the resource schedule based on the set of cost details accessible by the server; the scenario generator generating an at least one revised candidate schedule containing each of the resources in the revised scene list, based on the resource availability associated with each of said resources along with an at least one resource rule associated with each of said resources; for each of the at least one revised candidate schedule, the cost estimator module generating a total schedule cost for said candidate schedule based on an aggregate of the resource cost associated with the resource availability for each of the resources in said candidate schedule; the master schedule module selecting a one of the at least one revised candidate schedule; the master schedule module establishing a resource reservation for each of the resources based on the resource availability for each of the resources in said selected candidate schedule; and the master schedule module generating a revised master schedule containing each of the resource reservations for said entertainment production.

12. The method according to embodiments 1-11, further comprising the steps of, upon at least one of the resource reservations for said entertainment production changing: for each resource in the resource list of each planned scene in the scene list: the master schedule module generating a revised resource schedule containing at least one resource availability for said resource, cach of the at least one resource availability being a date and time at which said resource is currently available to be used for said entertainment production; and the cost estimator module generating a resource cost for each of the at least one resource availability in the revised resource schedule based on the set of cost details accessible by the server; the scenario generator generating an at least one candidate schedule containing each of the resources in the scene list, based on the resource availability associated with each of said resources along with an at least one resource rule associated with each of said resources; for each of the at least one candidate schedule, the cost estimator module generating a total schedule cost for said candidate schedule based on an aggregate of the resource cost associated with the resource availability for each of the resources in said candidate schedule; the master schedule module selecting a one of the at least one candidate schedule; the master schedule module establishing a resource reservation for each of the resources based on the resource availability for each of the resources in said selected candidate schedule; and the master schedule module generating a revised master schedule containing each of the resource reservations for said entertainment production.

13. An entertainment management system for managing entertainment production resources and dynamically generating production schedules and production budgets based on an availability of said resources, the system comprising: a server configured for receiving and processing data related to a plurality of members associated with an at least one entertainment production and a plurality of resources associated with the at least one entertainment production; a master schedule module in memory on the server, the master schedule module configured for storing the data related to the members and resources associated with the at least one entertainment production; a scenario generator in memory on the server, the scenario generator configured for generating a plurality of candidate schedules for the at least one entertainment production; and a cost estimator module in memory on the server, the cost estimator module configured for generating cost estimates for cach candidate schedule based on a set of cost details accessible by the server, said cost details including at least one of a general cost rule or a union pay rule; whercin, upon a new entertainment production being added to the master schedule module, the system is configured for: receiving, via the master schedule module, a scene or shot list containing a plurality of planned scenes for said entertainment production; for each planned scene in the scene list: generating, via the master schedule module, a resource list containing each of the plurality of resources associated with said planned scene; and for each resource in the resource list: generating, via the master schedule module, a resource schedule containing an at least one resource availability for said resource, each of the at least one resource availability being a date and time at which said resource is currently available to be used for said entertainment production; and generating, via the cost estimator module, a resource cost for each of the at least one resource availability in the resource schedule based on the set of cost details accessible by the server; generating, via the scenario generator, an at least one candidate schedule containing cach of the resources in the scene list, based on the resource availability associated with cach of said resources; for each of the at least one candidate schedule, generating, via the cost estimator module, a total schedule cost for said candidate schedule based on an aggregate of the resource cost associated with the resource availability for each of the resources in said candidate schedule; selecting, via the master schedule module, a one of the at least one candidate schedule; establishing, via the master schedule module, a resource reservation for each of the resources based on the resource availability for each of the resources in said selected candidate schedule; and generating, via the master schedule module, a master schedule containing each of the resource reservations for said entertainment production.

14. The entertainment management system according to embodiment 13, wherein upon the master schedule module determining the absence of data in the resource schedule associated with a given resource for a given planned scene, or an absence of data in the set of cost details accessible by the server, the system is further configured for transmitting, via the master schedule module, an alert notification to a producer of the associated entertainment production.

15. The entertainment management system according to embodiments 13-14, wherein for each resource in the resource list for a given planned scene, the system is further configured for storing, via the master schedule module, a resource provider containing select contact information for an at least one entity responsible for providing said resource.

16. The entertainment management system according to embodiments 13-15, wherein for each resource in the resource list for a given planned scene, the system is further configured for storing, via the master schedule module, an at least one authorized member associated with said entertainment production and having the authority to modify the at least one reservation associated with said resource.

17. The entertainment management system according to embodiments 13-16, wherein the system is further configured for distributing, via the master schedule module, select portions of the master schedule to the members associated with said entertainment production.

18. The entertainment management system according to embodiments 13-17, wherein the system is further configured for generating, via the master schedule module, a call sheet for cach planned scene for said entertainment production, said call sheet containing details related to each resource associated with said planned scene that is a living resource.

19. The entertainment management system according to embodiments 13-18, wherein while generating, via the scenario generator, an at least one candidate schedule, the system is further configured for: for each planned scene in the scene list: obtaining, via the scenario generator, the resource list associated with said planned scene; for each resource in the resource list, obtaining, via the scenario generator, the at least one resource availability associated with said resource; identifying, via the scenario generator, at least one resource availability that is common amongst each of the resources in the resource list associated with said planned scene; and adding, via the scenario generator, said identified at least one resource availability to the at least one candidate schedule.

20. The entertainment management system according to embodiments 13-19, wherein the system is further configured for: for each planned scene in the scene list: upon the scenario generator determining that no resource availability exists that is common amongst each of the resources in the resource list associated with said planned scene: for each resource in the resource list, determining, via the scenario generator, an at least one potential resource availability associated with said resource, said at least one potential resource availability being a date and time at which said resource is not currently unavailable to be used for said entertainment production; identifying, via the scenario generator, at least one of a resource availability or potential resource availability for each of the resources in the resource list associated with said planned scene that is common amongst each of the resources in said resource list; upon the scenario generator confirming the identified resource availability or potential resource availability for each of the resources in said resource list, adding, via the scenario generator, said identified at least one resource availability or potential resource availability to the at least one candidate schedule; and upon the scenario generator determining that no resource availability or potential resource availability exists for one or more resources that is common amongst each of the resources in the resource list associated with said planned scene, requesting, via the scenario generator, a change of resource availability with respect to said one or more resources.

21. The entertainment management system according to embodiments 13-20, wherein while selecting, via the master schedule module, a one of the at least one candidate schedule, the system is further configured for selecting, via the master schedule module, the candidate schedule having the lowest total schedule cost amongst the at least one candidate schedule.

22. The entertainment management system according to embodiments 13-21, wherein while generating, via the master schedule module, a master schedule, the system is further configured for generating, via the master schedule module, a master schedule as a Gantt chart containing each of the resource reservations for said entertainment production.

23. The entertainment management system according to embodiments 13-22, wherein upon the scene list of a given entertainment production being revised, the system is further configured for: receiving, via the master schedule module, the revised scene list containing a plurality of planned scenes for said entertainment production; for each planned scene in the revised scene list: generating, via the master schedule module, a revised resource list containing each of the plurality of resources associated with said planned scene; and for each resource in the revised resource list: generating, via the master schedule module, a resource schedule containing an at least one resource availability for said resource, each of the at least one resource availability being a date and time at which said resource is currently available to be used for said entertainment production; and generating, via the cost estimator module, a resource cost for each of the at least one resource availability in the resource schedule based on the set of cost details accessible by the server; generating, via the scenario generator, an at least one revised candidate schedule containing each of the resources in the revised scene list, based on the resource availability associated with each of said resources; for each of the at least one revised candidate schedule, generating, via the cost estimator module, a total schedule cost for said candidate schedule based on an aggregate of the resource cost associated with the resource availability for each of the resources in said candidate schedule; selecting, via the master schedule module, a one of the at least one revised candidate schedule; establishing, via the master schedule module, a resource reservation for each of the resources based on the resource availability for each of the resources in said selected candidate schedule; and generating, via the master schedule module, a revised master schedule containing each of the resource reservations for said entertainment production.

24. The entertainment management system according to embodiments 13-23, wherein upon at least one of the resource reservations for said entertainment production changing, the system is further configured for: for each resource in the resource list of each planned scene in the scene list: generating, via the master schedule module, a revised resource schedule containing at least one resource availability for said resource, each of the at least one resource availability being a date and time at which said resource is currently available to be used for said entertainment production; and generating, via the cost estimator module, a resource cost for each of the at least one resource availability in the revised resource schedule based on the set of cost details accessible by the server; generating, via the scenario generator, an at least one candidate schedule containing each of the resources in the scene list, based on the resource availability associated with each of said resources; for each of the at least one candidate schedule, generating, via the cost estimator module, a total schedule cost for said candidate schedule based on an aggregate of the resource cost associated with the resource availability for each of the resources in said candidate schedule; selecting, via the master schedule module, a one of the at least one candidate schedule; establishing, via the master schedule module, a resource reservation for each of the resources based on the resource availability for each of the resources in said selected candidate schedule; and generating, via the master schedule module, a revised master schedule containing each of the resource reservations for said entertainment production.

25. The entertainment management system according to embodiments 13-24, further comprising a script database in communication with the server and configured for storing an at least one script associated with the at least one entertainment production.

26. The entertainment management system according to embodiments 13-25, further comprising a resource database in communication with the server and configured for storing select details associated with each of the plurality of resources associated with the at least one entertainment production.

27. A non-transitory computer readable medium containing program instructions for causing an at least one computing device to perform a method of managing entertainment production resources and dynamically generating production schedules and production budgets based on an availability of said resources, the method comprising the steps of: implementing a master schedule module in memory on the computing device, the master schedule module configured for storing the data related to a plurality of members associated with an at least one entertainment production and a plurality of resources associated with the at least one entertainment production; implementing a scenario generator in memory on the computing device, the scenario generator configured for generating a plurality of candidate schedules for the at least one entertainment production; implementing a cost estimator module in memory on the computing device, the cost estimator module configured for generating cost estimates for each candidate schedule based on a set of cost details accessible by the computing device, said cost details including at least one of a general cost rule or a union pay rule; and upon a new entertainment production being added to the master schedule module: the master schedule module receiving a scene list containing a plurality of planned scenes for said entertainment production; for each planned scene in the scene list: the master schedule module generating a resource list containing cach of the plurality of resources associated with said planned scene; and for each resource in the resource list: the master schedule module generating a resource schedule containing an at least one resource availability for said resource, each of the at least one resource availability being a date and time at which said resource is currently available to be used for said entertainment production; and the cost estimator module generating a resource cost for each of the at least one resource availability in the resource schedule based on the set of cost details accessible by the computing device; the scenario generator generating an at least one candidate schedule containing each of the resources in the scene list, based on the resource availability associated with each of said resources along with an at least one resource rule associated with each of said resources; for each of the at least one candidate schedule, the cost estimator module generating a total schedule cost for said candidate schedule based on an aggregate of the resource cost associated with the resource availability for each of the resources in said candidate schedule; the master schedule module selecting a one of the at least one candidate schedule; the master schedule module establishing a resource reservation for each of the resources based on the resource availability for each of the resources in said selected candidate schedule; and the master schedule module generating a master schedule containing each of the resource reservations for said entertainment production.

28. The method according to embodiment 27, further comprising the step of, upon the master schedule module determining the absence of data in the resource schedule associated with a given resource for a given planned scene, or an absence of data in the set of cost details accessible by the computing device, the master schedule module transmitting an alert notification to a producer of the associated entertainment production.

29. The method according to embodiments 27-26, further comprising the step of, for each resource in the resource list for a given planned scene, the master schedule module storing a resource provider containing select contact information for an at least one entity responsible for providing said resource.

30. The method according to embodiments 27-27, further comprising the step of, for each resource in the resource list for a given planned scene, the master schedule module storing an at least one authorized member associated with said entertainment production and having the authority to modify the at least one reservation associated with said resource.

31. The method according to embodiments 27-28, further comprising the step of the master schedule module distributing select portions of the master schedule to the members associated with said entertainment production.

32. The method according to embodiments 27-29, further comprising the step of the master schedule module generating a call sheet for each planned scene for said entertainment production, said call sheet containing details related to each resource associated with said planned scene that is a living resource.

33. The method according to embodiments 27-30, wherein the step of the scenario generator generating an at least one candidate schedule further comprises the steps of: for each planned scene in the scene list: the scenario generator obtaining the resource list associated with said planned scene; for each resource in the resource list, the scenario generator obtaining the at least one resource availability associated with said resource; the scenario generator identifying at least one resource availability that is common amongst each of the resources in the resource list associated with said planned scene; and the scenario generator adding said identified at least one resource availability to the at least one candidate schedule.

34. The method according to embodiments 27-31, further comprising the steps of: for cach planned scene in the scene list: upon the scenario generator determining that no resource availability exists that is common amongst each of the resources in the resource list associated with said planned scene: for each resource in the resource list, the scenario generator determining an at least one potential resource availability associated with said resource, said at least one potential resource availability being a date and time at which said resource is not currently unavailable to be used for said entertainment production; the scenario generator identifying at least one of a resource availability or potential resource availability for each of the resources in the resource list associated with said planned scene that is common amongst each of the resources in said resource list; upon the scenario generator confirming the identified resource availability or potential resource availability for each of the resources in said resource list, the scenario generator adding said identified at least one resource availability or potential resource availability to the at least one candidate schedule; and upon the scenario generator determining that no resource availability or potential resource availability exists for one or more resources that is common amongst each of the resources in the resource list associated with said planned scene, the scenario generator requesting a change of resource availability with respect to said one or more resources.

35. The method according to embodiments 27-32, wherein the step of the master schedule module selecting a one of the at least one candidate schedule further comprises the step of the master schedule module selecting the candidate schedule having the lowest total schedule cost amongst the at least one candidate schedule.

36. The method according to embodiments 27-33, wherein the step of the master schedule module generating a master schedule further comprises the step of the master schedule module generating a master schedule as a Gantt chart containing each of the resource reservations for said entertainment production.

37. The method according to embodiments 27-34, further comprising the steps of, upon the scene list of a given entertainment production being revised: the master schedule module receiving the revised scene list containing a plurality of planned scenes for said entertainment production; for each planned scene in the revised scene list: the master schedule module generating a revised resource list containing each of the plurality of resources associated with said planned scene; and for each resource in the revised resource list: the master schedule module generating a resource schedule containing an at least one resource availability for said resource, each of the at least one resource availability being a date and time at which said resource is currently available to be used for said entertainment production; and the cost estimator module generating a resource cost for each of the at least one resource availability in the resource schedule based on the set of cost details accessible by the computing device; the scenario generator generating an at least one revised candidate schedule containing cach of the resources in the revised scene list, based on the resource availability associated with each of said resources along with an at least one resource rule associated with each of said resources; for each of the at least one revised candidate schedule, the cost estimator module generating a total schedule cost for said candidate schedule based on an aggregate of the resource cost associated with the resource availability for each of the resources in said candidate schedule; the master schedule module selecting a one of the at least one revised candidate schedule; the master schedule module establishing a resource reservation for each of the resources based on the resource availability for each of the resources in said selected candidate schedule; and the master schedule module generating a revised master schedule containing each of the resource reservations for said entertainment production.

38. The method according to embodiments 27-35, further comprising the steps of, upon at least one of the resource reservations for said entertainment production changing: for cach resource in the resource list of cach planned scene in the scene list: the master schedule module generating a revised resource schedule containing at least one resource availability for said resource, cach of the at least one resource availability being a date and time at which said resource is currently available to be used for said entertainment production; and the cost estimator module generating a resource cost for each of the at least one resource availability in the revised resource schedule based on the set of cost details accessible by the computing device; the scenario generator generating an at least one candidate schedule containing cach of the resources in the scene list, based on the resource availability associated with each of said resources along with an at least one resource rule associated with each of said resources; for each of the at least one candidate schedule, the cost estimator module generating a total schedule cost for said candidate schedule based on an aggregate of the resource cost associated with the resource availability for each of the resources in said candidate schedule; the master schedule module selecting a one of the at least one candidate schedule; the master schedule module establishing a resource reservation for each of the resources based on the resource availability for each of the resources in said selected candidate schedule; and the master schedule module generating a revised master schedule containing each of the resource reservations for said entertainment production.

39. An entertainment management system for managing entertainment production resources and dynamically generating production schedules and production budgets based on an availability of said resources, the system comprising: a server configured for receiving and processing data related to a plurality of members associated with an at least one entertainment production and a plurality of resources associated with the at least one entertainment production; a script database in communication with the server and configured for storing an at least one script associated with the at least one entertainment production; a resource database in communication with the server and configured for storing select details associated with each of the plurality of resources associated with the at least one entertainment production; a scenario generator in memory on the server, the scenario generator configured for generating a plurality of candidate schedules for the at least one entertainment production based on an availability of each resource associated with the at least one entertainment production; and a cost estimator module in memory on the server, the cost estimator module configured for generating cost estimates for each candidate schedule based on a set of cost details accessible by the server, said cost details including at least one of a general cost rule or a union pay rule.

40. The entertainment management system according to embodiment 39, further comprising a thread tracker configured for linking multiple scenes having related resources, wherein upon a scene within the at least one script associated with the at least one entertainment production being deleted from said script, the thread tracker is configured for alerting the user if the deleted scene is part of a thread, and notifies the user of the other parts of the thread, to make sure the removal of the deleted scene doesn't break the thread.

41. The entertainment management system according to embodiments 39-40, further comprising a virtual reader configured for allowing a user to create a self-tape audition without the assistance of an in-person reader, by either reading the lines of other characters in the scene utilizing synthesized text-to-speech engine, or utilizing a self-made audio recording.

42. The entertainment management system according to embodiments 39-41, further comprising a footage playback module configured for linking captured footage with corresponding portions of the at least one script associated with the at least one entertainment production, thereby allowing for instant playback of captured footage.

43. The entertainment management system according to embodiments 39-42, wherein the footage playback module is further configured for linking captured footage with corresponding script supervisor notes.

In closing, regarding the exemplary embodiments of the present invention as shown and described herein, it will be appreciated that an entertainment management system and associated methods are disclosed and configured for developing and managing entertainment projects. Because the principles of the invention may be practiced in a number of configurations beyond those shown and described, it is to be understood that the invention is not in any way limited by the exemplary embodiments, but is generally directed to an entertainment management system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, cach numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to cach separate numerical value falling within the range. Unless otherwise indicated herein, cach individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators-such as “first,” “second,” “third,” etc.-for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. §112(f) will begin with the words “means for,” but use of the term “for” in any other context is not intended to invoke treatment under 35 U.S.C. §112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

One or more embodiments of the present invention may be implemented with one or more computer readable media, wherein each medium may be configured to include thereon data or computer executable instructions for manipulating data. The computer executable instructions include data structures, objects, programs, routines, or other program modules that may be accessed by a processing system, such as one associated with a general-purpose computer or processor capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), crasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. Examples of mass storage devices incorporating computer readable media include hard disk drives, magnetic disk drives, tape drives, optical disk drives, and solid state memory chips, for example. The mass storage devices may be local to the computer or in cloud storage, for example, accessible via the Internet. The term processor as used herein refers to a number of processing devices including personal computing devices, servers, general purpose computers, special purpose computers, mobile phones, tablets, application-specific integrated circuit (ASIC), digital/analog circuits with discrete components, and cloud computing devices accessible via the Internet, for example. Discrete components, logic devices, and/or processors may be combined to form one or more electronic circuits configured to perform the functions, operations, and processes described herein.

The phrase “non-transitory,” in addition to having its ordinary meaning, as used in this document means “enduring or long-lived”. The phrase “non-transitory computer readable medium,” in addition to having its ordinary meaning, includes any and all computer readable mediums, with the sole exception of a transitory, propagating signal. This includes, by way of example and not limitation, non-transitory computer-readable mediums such as register memory, processor cache and random-access memory (“RAM”).

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicant and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for managing entertainment production and dynamically generating production schedules and production budgets based on an availability and contractual scheduling rules of resources, the method comprising steps of:
implementing a server configured for receiving and processing data related to a plurality of members associated with an at least one entertainment production and a plurality of resources associated with the at least one entertainment production;
implementing a master schedule process in a memory on the server, the master schedule process configured for storing the data related to the plurality of members and plurality of resources associated with the at least one entertainment production;
implementing a scenario generator configured for generating a plurality of candidate schedules for the at least one entertainment production;
implementing a cost estimator process configured for generating cost estimates for each candidate schedule based on a set of cost details accessible by the server; and
upon a new entertainment production being added to the master schedule process:
the master schedule process receiving a list of units of scheduled work comprising at least one unit of scheduled work for said new entertainment production;
for each unit of scheduled work:
the master schedule process receiving a resource list containing each of the plurality of resources associated with said unit of scheduled work; and
for each resource in the resource list:
the master schedule process generating a resource schedule containing an at least one resource availability for said resource, each of the at least one resource availability being a date and time at which said resource is currently available to be used for said entertainment production; and
the cost estimator process generating a resource cost for each of the at least one resource availability in the resource schedule based on the set of cost details accessible by the server;
the scenario generator generating an at least one candidate schedule containing each of the resources associated with the unit of scheduled work, based on the resource availability associated with each of said resources along with an at least one resource rule associated with each of said resources;
for each of the at least one candidate schedule, the cost estimator process generating a total schedule cost for said candidate schedule based on an aggregate of the resource cost associated with the resource availability for each of the resources in said candidate schedule;
the master schedule process selecting a one of the at least one candidate schedule;
the master schedule process concurrently transmitting a resource reservation for each of the resources based on the resource availability for each of the resources in said selected candidate schedule; and
the master schedule process generating a master schedule containing each of the resource reservations for said entertainment production.

2. The method of claim 1, further comprising the step of, for each resource in the resource list for a given unit of scheduled work, the master schedule process storing an at least one authorized member associated with the new entertainment production and having an authority to modify an at least one reservation associated with said resource.

3. The method of claim 1, further comprising the step of the master schedule process distributing select portions of the master schedule to the plurality of members associated with the at least one entertainment production.

4. The method of claim 1, wherein the step of the scenario generator generating the at least one candidate schedule further comprises the steps of:
for each unit of scheduled work:
the scenario generator obtaining the resource list associated with said unit of scheduled work;
for each resource in the resource list, the scenario generator obtaining the at least one resource availability associated with said resource;
the scenario generator identifying at least one resource availability that is common amongst each of the resources in the resource list associated with unit of scheduled work; and
the scenario generator adding said identified at least one resource availability to the at least one candidate schedule.

5. The method of claim 4, further comprising the steps of:
for each unit of scheduled work:
upon the scenario generator determining that no resource availability exists that is common amongst each of the resources in the resource list associated with said unit of scheduled work:
for each resource in the resource list, the scenario generator determining an at least one potential resource availability associated with said resource, said at least one potential resource availability being a date and time at which said resource is not currently unavailable to be used for said entertainment production;
the scenario generator identifying at least one of a resource availability or potential resource availability for each of the resources in the resource list associated with said unit of scheduled work that is common amongst each of the resources in said resource list;
upon the scenario generator confirming the identified resource availability or potential resource availability for each of the resources in said resource list, the scenario generator adding said identified at least one resource availability or potential resource availability to the at least one candidate schedule; and
upon the scenario generator determining that no resource availability or potential resource availability exists for one or more resources that is common amongst each of the resources in the resource list associated with said unit of scheduled work, the scenario generator requesting a change of resource availability with respect to said one or more resources.

6. The method of claim 1, wherein the step of the master schedule process selecting a one of the at least one candidate schedule further comprises the step of the master schedule process selecting the candidate schedule having a lowest total schedule cost amongst the at least one candidate schedule.

7. The method of claim 1, further comprising the steps of, upon the list of units of scheduled work of a given entertainment production being revised:
the master schedule process receiving the revised list of units of scheduled work for said entertainment production;
for each unit of scheduled work in the revised list of units of scheduled work:
the master schedule process receiving a revised resource list containing each of the plurality of resources associated with said unit of scheduled work; and
for each resource in the revised resource list:
the master schedule process generating a resource schedule containing an at least one resource availability for said resource, each of the at least one resource availability being a date and time at which said resource is currently available to be used for said entertainment production; and
the cost estimator process generating a resource cost for each of the at least one resource availability in the resource schedule based on the set of cost details accessible by the server;
the scenario generator generating an at least one revised candidate schedule containing each of the resources in the revised list of units of scheduled work, based on the resource availability associated with each of said resources along with an at least one resource rule associated with each of said resources;
for each of the at least one revised candidate schedule, the cost estimator process generating a total schedule cost for said candidate schedule based on an aggregate of the resource cost associated with the resource availability for each of the resources in said candidate schedule;
the master schedule process selecting a one of the at least one revised candidate schedule;
the master schedule process concurrently transmitting a resource reservation for each of the resources based on the resource availability for each of the resources in said selected candidate schedule; and
the master schedule process generating a revised master schedule containing each of the resource reservations for said entertainment production.

8. The method of claim 1, further comprising the steps of, upon at least one of the resource reservations for said entertainment production changing:
for each resource in the resource list of each unit of scheduled work:
the master schedule process generating a revised resource schedule containing at least one resource availability for said resource, each of the at least one resource availability being a date and time at which said resource is currently available to be used for said entertainment production; and
the cost estimator process generating a resource cost for each of the at least one resource availability in the revised resource schedule based on the set of cost details accessible by the server;
the scenario generator generating an at least one candidate schedule containing each of the resources in the list of units of scheduled work, based on the resource availability associated with each of said resources along with an at least one resource rule associated with each of said resources;
for each of the at least one candidate schedule, the cost estimator process generating a total schedule cost for said candidate schedule based on an aggregate of the resource cost associated with the resource availability for each of the resources in said candidate schedule;
the master schedule process selecting a one of the at least one candidate schedule;
the master schedule process concurrently transmitting a resource reservation for each of the resources based on the resource availability for each of the resources in said selected candidate schedule; and
the master schedule process generating a revised master schedule containing each of the resource reservations for said entertainment production.

9. The method of claim 5, wherein the step of requesting the change of resource availability with respect to said one or more resources comprises a system automatically contacting relevant members in a project, collecting their responses, and updating an availability status of said one or more resources.

10. The method of claim 1, wherein the at least one resource is a location that is not a sound stage, a system dynamically considers weather reports associated with the location.

11. A modular entertainment development system comprising:
a server configured for receiving and processing data related to a plurality of members associated with an at least one entertainment production and a plurality of resources associated with the at least one entertainment production;
a master schedule processor configured for storing the data related to the plurality of members and the plurality of resources associated with the at least one entertainment production;
a scenario generator configured for generating a plurality of candidate schedules for the at least one entertainment production; and
a cost estimator processor configured for generating cost estimates for each candidate schedule based on a set of cost details accessible by the server;
wherein, upon a new entertainment production being added to the master schedule processor, the system is configured for:
receiving, via the master schedule processor, a list of units of scheduled work comprising at least one unit of scheduled work for said new entertainment production;
for each unit of scheduled work:
receiving, via the master schedule processor, a resource list containing each of the plurality of resources associated with said unit of scheduled work; and
for each resource in the resource list:
generating, via the master schedule processor, a resource schedule containing an at least one resource availability for said resource, each of the at least one resource availability being a date and time at which said resource is currently available to be used for said entertainment production; and
generating, via the cost estimator processor, a resource cost for each of the at least one resource availability in the resource schedule based on the set of cost details accessible by the server;
generating, via the scenario generator, the at least one candidate schedule containing each of the resources in the list of units of scheduled work, based on the resource availability associated with each of said resources;
for each of the at least one candidate schedule, generating, via the cost estimator processor, a total schedule cost for said candidate schedule based on an aggregate of the resource cost associated with the resource availability for each of the resources in said candidate schedule;
selecting, via the master schedule processor, a one of the at least one candidate schedule;
concurrently transmitting in real-time, via the master schedule processor, a resource reservation for each of the resources based on the resource availability for each of the resources in said selected candidate schedule; and
generating, via the master schedule processor, a master schedule containing each of the resource reservations for said entertainment production.

12. The modular entertainment development system of claim 11, wherein while generating, via the scenario generator, an at least one candidate schedule, the system is further configured for:
for each unit of scheduled work:
obtaining, via the scenario generator, the resource list associated with said unit of scheduled work;
for each resource in the resource list, obtaining, via the scenario generator, the at least one resource availability associated with said resource;
identifying, via the scenario generator, at least one resource availability that is common amongst each of the resources in the resource list associated with said unit of scheduled work; and
adding, via the scenario generator, said identified at least one resource availability to the at least one candidate schedule.

13. The modular entertainment development system of claim 12, wherein the system is further configured for:
for each unit of scheduled work:
upon the scenario generator determining that no resource availability exists that is common amongst each of the resources in the resource list associated with said unit of scheduled work:
for each resource in the resource list, determining, via the scenario generator, an at least one potential resource availability associated with said resource, said at least one potential resource availability being a date and time at which said resource is not currently unavailable to be used for said entertainment production;
identifying, via the scenario generator, at least one of a resource availability or potential resource availability for each of the resources in the resource list associated with said unit of scheduled work that is common amongst each of the resources in said resource list;
upon the scenario generator confirming the identified resource availability or potential resource availability for each of the resources in said resource list, adding, via the scenario generator, said identified at least one resource availability or potential resource availability to the at least one candidate schedule; and
upon the scenario generator determining that no resource availability or potential resource availability exists for one or more resources that is common amongst each of the resources in the resource list associated with said unit of scheduled work, requesting, via the scenario generator, a change of resource availability with respect to said one or more resources.

14. The modular entertainment development system of claim 11, wherein while selecting, via the master schedule processor, the one of the at least one candidate schedule, the system is further configured for selecting, via the master schedule processor, the candidate schedule having a lowest total schedule cost amongst the at least one candidate schedule.

15. The modular entertainment development system of claim 11, wherein upon the list of units of scheduled work of a given entertainment production being revised, the system is further configured for:
receiving, via the master schedule processor, the revised list of units of scheduled work for said entertainment production;
for each unit of scheduled work in the revised list of units of scheduled work receiving, via the master schedule processor, a revised resource list containing each of the plurality of resources associated with said unit of scheduled work; and
for each resource in the revised resource list:
generating, via the master schedule processor, a resource schedule containing an at least one resource availability for said resource, each of the at least one resource availability being a date and time at which said resource is currently available to be used for said entertainment production; and
generating, via the cost estimator processor, a resource cost for each of the at least one resource availability in the resource schedule based on the set of cost details accessible by the server;
generating, via the scenario generator, an at least one revised candidate schedule containing each of the resources in the revised list of units of scheduled work, based on the resource availability associated with each of said resources;
for each of the at least one revised candidate schedule, generating, via the cost estimator processor, a total schedule cost for said candidate schedule based on an aggregate of the resource cost associated with the resource availability for each of the resources in said candidate schedule;
selecting, via the master schedule processor, a one of the at least one revised candidate schedule;
concurrently transmitting in real-time, via the master schedule processor, a resource reservation for each of the resources based on the resource availability for each of the resources in said selected candidate schedule; and
generating, via the master schedule processor, a revised master schedule containing each of the resource reservations for said entertainment production.

16. The modular entertainment development system of claim 11, wherein upon at least one of the resource reservations for said entertainment production changing, the system is further configured for:
for each resource in the resource list of each unit of scheduled work:
generating, via the master schedule processor, a revised resource schedule containing at least one resource availability for said resource, each of the at least one resource availability being a date and time at which said resource is currently available to be used for said entertainment production; and
generating, via the cost estimator processor, a resource cost for each of the at least one resource availability in the revised resource schedule based on the set of cost details accessible by the server;
generating, via the scenario generator, an at least one candidate schedule containing each of the resources in the unit of scheduled work, based on the resource availability associated with each of said resources;
for each of the at least one candidate schedule, generating, via the cost estimator processor, a total schedule cost for said candidate schedule based on an aggregate of the resource cost associated with the resource availability for each of the resources in said candidate schedule;
selecting, via the master schedule processor, a one of the at least one candidate schedule;
concurrently transmitting in real-time, via the master schedule processor, a resource reservation for each of the resources based on the resource availability for each of the resources in said selected candidate schedule; and
generating, via the master schedule processor, a revised master schedule containing each of the resource reservations for said entertainment production.

17. A modular entertainment development system that automates and optimizes scheduling and dynamically generating production schedules, the modular entertainment development system comprising:
a server configured for receiving and processing data related to a plurality of members associated with an at least one entertainment production and a plurality of resources associated with the at least one entertainment production;
a script database in communication with the server and configured for storing an at least one script associated with the at least one entertainment production;
a resource database in communication with the server and configured for storing select details associated with each of the plurality of resources associated with the at least one entertainment production;
a scenario generator configured for generating a plurality of candidate schedules for the at least one entertainment production based on an availability of each resource associated with the at least one entertainment production; and
a cost estimator processor configured for generating cost estimates for each candidate schedule based on a set of cost details accessible by the server.
